(19) United States
(12) Patent Application Publication
(10) Pub. No.: US 2026/0346733 A1
(43) Pub. Date: Nov. 5, 2026

(54) DRIVE AXLE SYSTEMS AND METHODS OF CONTROL

(71) Applicant: TRACTION DRIVE HOLDCO LLC, Columbus, IN (US)

(72) Inventors: Edvin Godo, Troy, MI (US); Banuchandar Muthukumar, Rochester Hills, MI (US)

(73) Assignee: TRACTION DRIVE HOLDCO LLC, Columbus, IN (US)

(21) Appl. No.: 19/196,397

(22) Filed: May 1, 2025

(51) Int. Cl. B60L 15/20; B60K 1/02; B60K 17/02; B60K 17/16

(52) U.S. Cl. CPC B60L 15/20; B60K 17/02; B60K 17/165; B60K 1/02; B60L 2240/421; B60L 2240/423; B60L 2240/46; B60L 2240/486; B60L 2240/50

(57) ABSTRACT

A drive axle system and a method of control. The method includes commanding a shift collar to move to a neutral position, changing a rotational speed of the electric motor, and determining whether there is acceleration in response to changing the rotational speed of the electric motor. Output torque provided by the electric motor is reduced when acceleration is detected.

### TECHNICAL FIELD

This relates to drive axle systems for a vehicle that comprise at least one electric motor and methods of control.

### BACKGROUND

A drive axle system and a method of control is disclosed in U.S. Pat. No. 11,984,832.

### SUMMARY

A method of controlling a drive axle system is disclosed. The method comprises commanding a shift collar to move to a neutral position to disconnect an electric motor from a wheel hub, changing a rotational speed of the electric motor after commanding the shift collar to move to the neutral position, determining whether there is acceleration in response to changing the rotational speed of the electric motor, and reducing output torque provided by the electric motor when acceleration is detected.

The shift collar may not be in the neutral position when acceleration is detected. The shift collar may be coupled to a gear of a transmission that is connected to the electric motor when acceleration is detected. The shift collar may be in the neutral position and may not be coupled to a gear of the transmission when acceleration is not detected.

Reducing output torque provided by the electric motor may comprise providing no output torque or zero output torque with the electric motor.

The method may further comprise decreasing output torque provided by the electric motor before commanding the shift collar to move to the neutral position.

The method may further comprise moving the shift collar to the neutral position when acceleration is detected.

The method may further comprise providing a notification to a vehicle driver when acceleration is detected.

The shift collar may couple a gear of a transmission to a drive pinion that meshes with a differential assembly when acceleration is detected.

Determining whether there is acceleration in response to changing the rotational speed of the electric motor may comprise detecting acceleration of a drive pinion that meshes with a ring gear of a differential assembly. Determining whether there is acceleration in response to changing the rotational speed of the electric motor may comprise detecting acceleration of an axle shaft that is connected to the differential assembly. Determining whether there is acceleration in response to changing the rotational speed of the electric motor may comprise detecting acceleration of the wheel hub.

The method may further comprise synchronizing, with the electric motor, a rotational speed of a target gear of a transmission that is connected to the electric motor and a rotational speed of the shift collar when acceleration is not detected.

The method may further comprise actuating the shift collar to engage the target gear after synchronizing the rotational speed of the target gear with the rotational speed of the shift collar.

The invention relates to a drive axle system. The drive axle system comprises an electric motor, a transmission connected to the electric motor, the transmission comprising at least a first gear and a second gear, a differential assembly connectable to first and second wheel hubs, respectively, a drive pinion that meshes with a ring gear of the differential assembly, a shift collar that is moveable between a first position in which the shift collar engages the first gear, a second position in which the shift collar engages the second gear, and a neutral position in which the shift collar does not engage the first gear and the second gear, and a control system that controls the electric motor and actuation of the shift collar. The control system is configured to: command the shift mechanism to move the shift collar to the neutral position to disconnect the electric motor from the differential assembly, change a rotational speed of the electric motor after commanding the shift collar to move to the neutral position, determine whether there is acceleration in response to changing the rotational speed of the electric motor, and reduce output torque provided by the electric motor when acceleration is detected.

No output torque or zero output torque may be provided by the electric motor when the output torque is reduced.

The shift collar may be moveable along the drive pinion and rotatable with the drive pinion. The shift collar may engage or be in engagement with the first gear or the second gear when acceleration in response to changing the rotational speed of the electric motor is detected.

Acceleration in response to changing the rotational speed of the electric motor may be acceleration of the drive pinion, differential assembly, axle shaft, wheel hub, or combinations thereof caused by the electric motor.

The drive axle system may further comprise an operator communication device. The control system may provide a notification to a vehicle driver when there is acceleration in response to changing the rotational speed of the electric motor.

### BRIEF DESCRIPTION OF THE DRAWINGS

FIG. 1 is a schematic representation of an example of a vehicle comprising a drive axle system that comprises at least one axle assembly.

FIG. 2 is a perspective view of an example of an axle assembly.

FIG. 3 is a section view of the axle assembly along section line 3-3,

FIG. 4 is a section view of the axle assembly along section line 4-4.

FIG. 5 is a perspective view of an example of a shift mechanism that may be provided with the axle assembly.

FIG. 6 is a section view of a portion of the axle assembly along section line 6-6 showing an example of a coupling in a first position.

FIG. 7 is a section view of a portion of the axle assembly in FIG. 6 with the coupling in a first neutral position.

FIG. 8 is a section view of a portion of the axle assembly in FIG. 6 with the coupling in a second position.

FIG. 9 is a section view of a portion of the axle assembly in FIG. 6 with the coupling in a second neutral position.

FIG. 10 is a section view of a portion of the axle assembly in FIG. 6 with the coupling in a third position.

FIG. 11 is a flowchart of a first method of controlling the drive axle system.

FIG. 12 is a flowchart of a second method of controlling the axle assembly with the shift control device.

FIG. 13 is a flowchart of a third method of controlling the axle assembly with the shift control device.

FIG. 14 is a flowchart of a fourth method of controlling the axle assembly with the shift control device.

FIG. 15 is a flowchart of a fifth method of controlling the axle assembly with the shift control device.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

It will also be understood that, although the terms first, second, etc. are, in some instances, used herein to describe various elements, these elements should not be limited by these terms. These terms are only used to distinguish one element from another. For example, a first element could be termed a second element, and similarly a second element could be termed a first element without departing from the scope of the various described embodiments. The first element and the second element are both elements, but they are not the same element.

The terminology used in the description of the various described embodiments is for the purpose of describing particular embodiments only and is not intended to be limiting. As used in the description of the various described embodiments and the appended claims, the singular forms “a” and “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

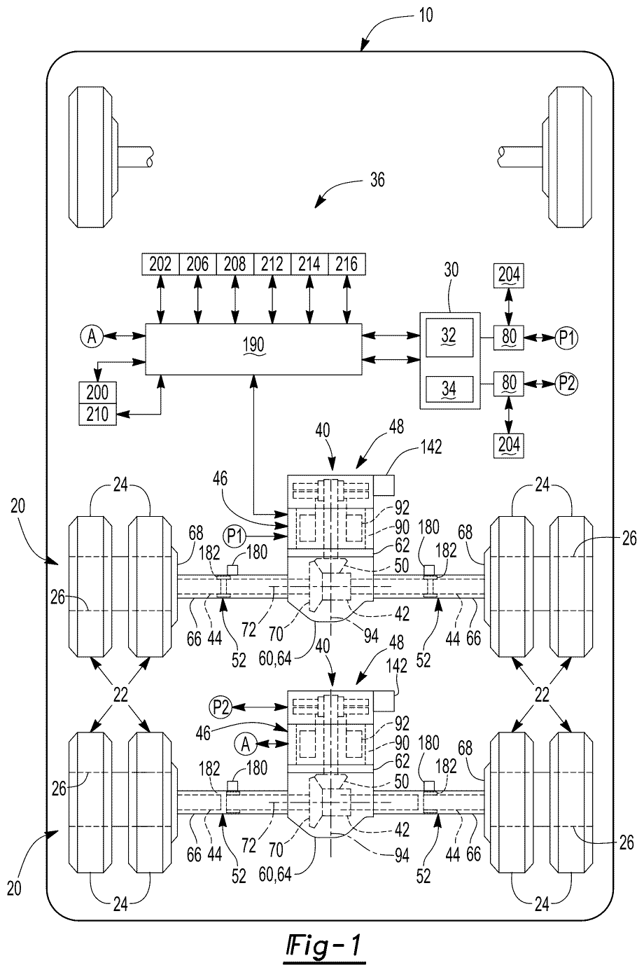

Referring to FIG. 1, an example of a vehicle 10 is shown. In some configurations, the vehicle 10 is a motor vehicle like a truck, farm equipment, military transport or weaponry vehicle, or cargo loading equipment for land, air, or marine vessels. The vehicle 10 may include a trailer for transporting cargo in one or more embodiments.

The vehicle 10 includes a drive axle system 12. The drive axle system 12 includes one or more axle assemblies 20, such as a front axle assembly and a rear axle assembly. Two axle assemblies 20 are illustrated in FIG. 1; however, it is contemplated that a greater or lesser number of axle assemblies may be provided. The axle assemblies 20 are illustrated as drive axle assemblies. A drive axle assembly is configured to provide torque to one or more wheel assemblies 22. In some configurations, one or more wheel assemblies 22 are rotatably supported on the axle assembly 20. A wheel assembly 22 may include a tire 24 disposed on a wheel 26.

The vehicle 10 includes an electric energy system 30. The electric energy system 30 may be associated with or be part of the drive axle system 12. In some configurations, the electric energy system includes a first electric power source 32 and a second electric power source 34. The vehicle 10 or drive axle system 12 also includes a control system 36.

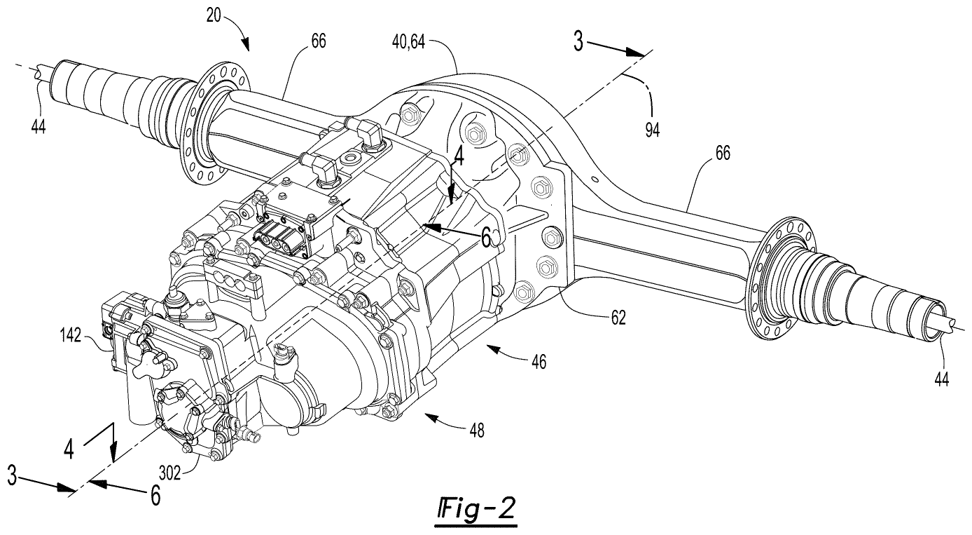

In some configurations, an axle assembly 20 includes a housing assembly 40, a differential assembly 42, a pair of axle shafts 44, an electric motor 46, a transmission 48, and a drive pinion 50. In some configurations, the axle assembly 20 includes one or more wheel disconnects 52. The positioning of the differential assembly 42, the electric motor 46, and/or the transmission 48 may differ from that shown. For instance, the differential assembly 42 may be positioned between the electric motor 46 and the transmission 48. It is also contemplated that the electric motor 46, the transmission 48, or both may be remotely positioned from the axle assembly 20 and may not be part of the axle assembly 20. For illustration purposes, the axle assembly 20 will be primarily described in the context of the configuration shown in FIGS. 1 and 2.

Referring primarily to FIG. 1, the housing assembly 40 receives various components of the axle assembly 20. In addition, the housing assembly 40 may facilitate mounting of the axle assembly 20 to the vehicle 10. In some configurations, the housing assembly 40 includes an axle housing 60 and a differential carrier 62.

The axle housing 60 may receive and support the axle shafts 44. In some configurations, the axle housing 60 includes a center portion 64 and at least one arm portion 66.

The center portion 64 may be disposed proximate the center of the axle housing 60. The center portion 64 may define a cavity that may receive the differential assembly 42.

One or more arm portions 66 may extend from the center portion 64. For example, two arm portions 66 may extend in opposite directions from the center portion 64 and away from the differential assembly 42. The arm portions 66 may each have a hollow configuration or tubular configuration that may extend around and may receive a corresponding axle shaft 44 and may help separate or isolate the axle shaft 44 from the surrounding environment.

A wheel hub 68 may be rotatably disposed on an arm portion 66 and may be rotatable about an axis. In some configurations, the wheel hubs 68 are rotatable about a common axis. A wheel hub 68 may be connected to a corresponding axle shaft 44. A wheel assembly 22 is mountable to the wheel hub 68.

The differential carrier 62 may be mounted to the center portion 64 of the axle housing 60. In some configurations, the differential assembly 42 is rotatably supported on the differential carrier 62.

The differential assembly 42 is disposed in the housing assembly 40. For instance, the differential assembly 42 may be disposed in the center portion 64 of the axle housing 60. The differential assembly 42, which may also be called an axle differential, is configured to transmit torque to the axle shafts 44 of the axle assembly 20 and permit the axle shafts 44 and wheel assemblies 22 to rotate at different velocities with respect to each other, such as when the vehicle is cornering or navigating a curve, in a manner known by those skilled in the art. For example, the differential assembly 42 may have a ring gear 70 that may be fixedly mounted on a differential case. The ring gear 70 and the differential case are rotatable about a differential axis 72. The differential case may receive and transmit torque to differential gears that may be operatively connected to the axle shafts 44.

The axle shafts 44 are configured to transmit torque between the differential assembly 42 and a corresponding wheel hub 68. For example, two axle shafts 44 may be provided with an axle assembly 20 such that each axle shaft 44 extends through a different arm portion 66 of axle housing 60. The axle shafts 44 may be rotatable about an axis, such as the differential axis 72 or a wheel axis. In some configurations, the wheel axis is the same as the differential axis 72. In some configurations, the wheel axis differs or is offset from the differential axis 72.

The electric motor 46 is configured to provide torque, such as propulsion torque or regenerative braking torque. Propulsion torque may be used to propel the vehicle 10, such as in a forward or backward direction. Propulsion torque may also be used to hold the vehicle 10 in a stationary position or to help reduce, limit, or prevent vehicle rollback, such as when the vehicle 10 is on an inclined surface. Regenerative braking provides a regenerative braking torque. Regenerative braking may capture kinetic energy when the electric motor 46 is used to brake or slow the velocity of the vehicle 10. Recovered energy may be transmitted from the wheel assemblies 22 to drive the electric motor 46. Thus, the electric motor 46 functions as a generator and may be used to charge the first electric power source 32, the second electric power source 34, or both. The electric motor 46 is electrically connected to the electric energy system 30, such as via an inverter 80, in a manner known by those skilled in the art.

In FIG. 1, examples of electrical connections between the front axle assembly 20 and the electric energy system 30 and between the rear axle assembly 20 and the electric energy system 30 are represented with connection symbols P1 and P2, respectively. In some configurations, the electric energy system 30 is electrically connected to both axle assemblies 20. In other configurations each axle assembly 20 may be electrically connected to a different electric energy system 30 or different electric power sources. For instance, a first energy storage system may be electrically connected to a first axle assembly but not to a second axle assembly while a second energy storage system may be electrically connected to the second axle assembly but not to the first axle assembly.

The electric motor 46 includes a stator 90 and a rotor 92. In some configurations, the stator 90 is fixedly positioned with respect to the housing assembly 40. The stator 90 may encircle the rotor 92. The rotor 92 is rotatable about an axis 94 with respect to the stator 90. The electric motor 46 may be mounted to or positioned inside of the housing assembly 40.

The transmission 48 facilitates the transmission of torque between the electric motor 46 and the drive pinion 50. Torque transmission may be bidirectional. The transmission 48 may provide gear reduction and multiple gear ratios between the rotor 92 and the drive pinion 50. The transmission 48 may be of any suitable type. For instance, the transmission 48 may be a countershaft transmission, an epicyclic transmission (e.g., a transmission comprising a planetary gear set), or the like. A countershaft transmission may include a single countershaft or multiple countershafts. Some examples of an axle assembly having a single countershaft transmission are disclosed in U.S. Pat. Nos. 11,002,352 and 11,209,072. Some examples of an axle assembly having a dual countershaft transmission is disclosed in in U.S. Pat. Nos. 10,989,288, 11,207,976, and 11,220,176. Some examples of an axle assembly having an epicyclic transmission are disclosed in U.S. Pat. Nos. 11,038,396 and 11,428,297. The disclosures of the references in the preceding three sentences are hereby incorporated in their entirety by reference herein.

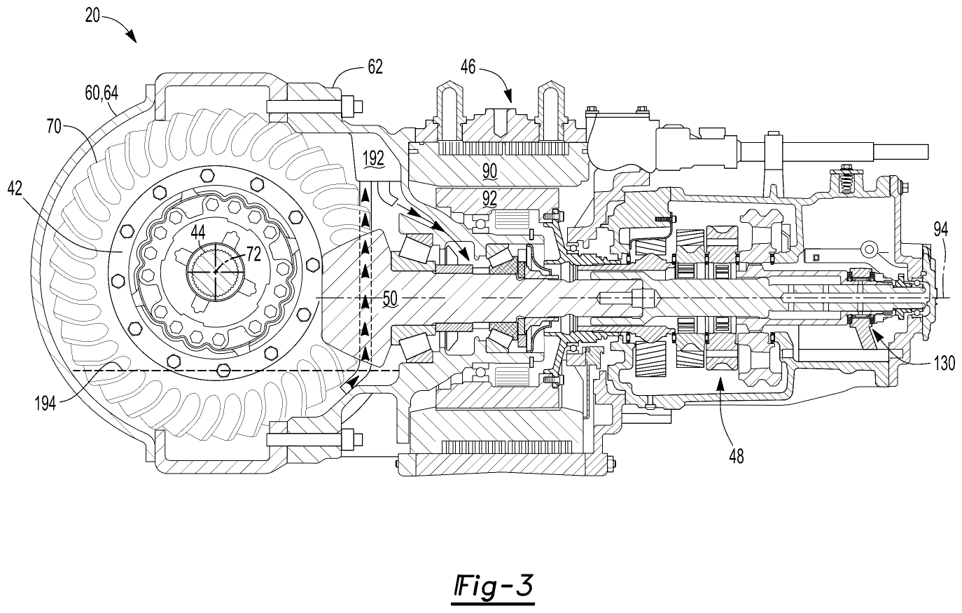

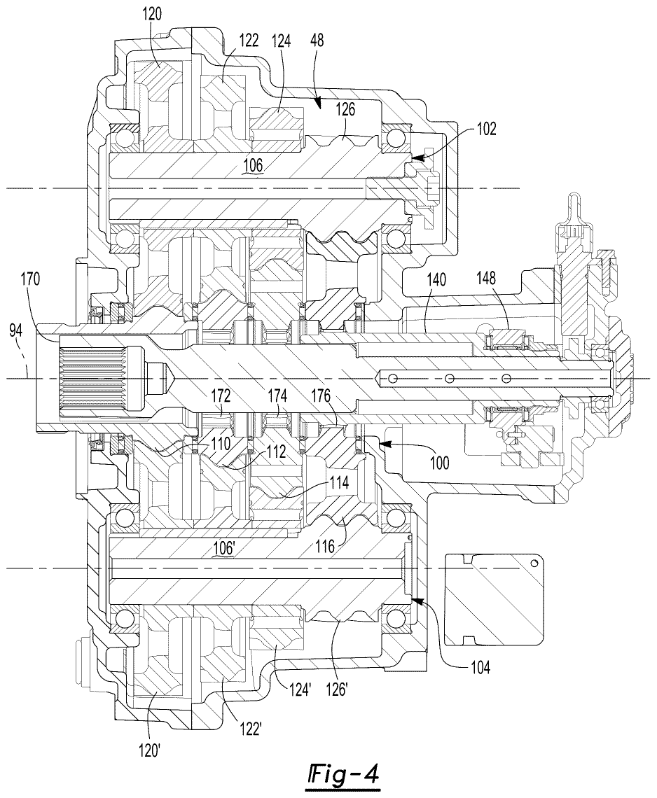

An example of a transmission 48 that is configured as a countershaft transmission is shown in FIGS. 3 and 4. As is best shown in FIG. 4, the transmission 48 may include a set of drive pinion gears 100, a first countershaft gear set 102, and optionally a second countershaft gear set 104. Gears of the first and second countershaft gear sets 102, 104 are disposed on and may be rotatable with first and second countershafts 106, 106′, respectively.

The set of drive pinion gears 100 may include a plurality of gears, some or all of which may be selectively coupled to the drive pinion 50. The gears may be independently rotatable with respect to each other. In the configuration shown, the set of drive pinion gears 100 includes a first gear 110, a second gear 112, a third gear 114, and a fourth gear 116; however, it is to be understood that a greater or lesser number of gears may be provided. The first gear 110 may mesh with one or more first countershaft gears 120, 120′. The second gear 112 may mesh with one or more second countershaft gears 122, 122′. The third gear 114 may mesh with one or more third countershaft gears 124, 124′. The fourth gear 116 may mesh with one or more fourth countershaft gears 126, 126′.

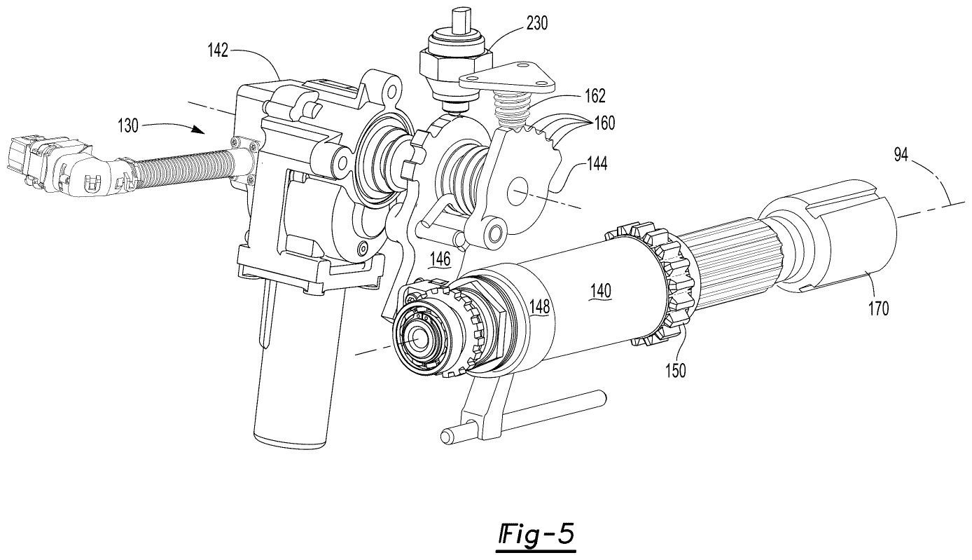

Referring primarily to FIG. 5, an example of a shift mechanism 130 is shown. The shift mechanism 130 is configured to selectively connect a member of the set of drive pinion gears 100 to the drive pinion 50. The shift mechanism 130 may couple one member of the set of drive pinion gears 100 at a time to the drive pinion 50. The member of the set of drive pinion gears 100 that is coupled to the drive pinion 50 may be rotatable about the axis 94 with the drive pinion 50.

The shift mechanism 130 may have any suitable configuration. In at least one configuration such as is shown in FIG. 5, the shift mechanism 130 may include a coupling 140, an actuator 142, a detent linkage 144, a linkage 146, and a collar 148.

The coupling 140, which may also be referred to as a shift collar or clutch collar, is rotatable about the axis 94 with the drive pinion 50. In addition, the coupling 140 may be moveable along the axis 94 with respect to the drive pinion 50. The coupling 140 may selectively connect a member of the set of drive pinion gears 100 to the drive pinion 50 as will be discussed in more detail below. In at least one configuration, the coupling 140 may include at least one coupling gear 150 that is engageable with different members of the set of drive pinion gears 100.

The actuator 142 is configured to move the coupling 140 along the axis 94 between a plurality of positions to selectively couple the coupling 140 to the transmission 48 or to decouple the coupling 140 from the transmission 48 as will be discussed in more detail below.

The detent linkage 144 is coupled to the actuator 142. For instance, the detent linkage 144 may be fixedly coupled to an actuator shaft of the actuator 142. The detent linkage 144 may define a plurality of recesses 160. The recesses 160 may be configured to receive a detent feature 162. The detent feature 162 may inhibit rotation of the detent linkage 144 and help hold the coupling 140 in a desired position along the axis 94.

The linkage 146, if provided, may operatively connect the detent linkage 144 to the collar 148.

The collar 148 may receive the coupling 140. The coupling 140 may be rotatably disposed in the collar 148 such that the coupling 140 may rotate about the axis 94 with respect to the collar 148.

The coupling 140 is moveable between at least one neutral position and one or more torque transmitting positions or “in gear” positions. The coupling 140 may selectively connect the drive pinion 50 to the transmission 48 when in a torque transmitting position. In some configurations, the coupling 140 selectively connects the drive pinion 50 to a member of the set of drive pinion gears 100. In the discussion below, reference to connecting or disconnecting a member of the set of drive pinion gears 100 to/from the drive pinion 50 includes direct and indirect connections to and direct and indirect disconnections from the drive pinion 50. For instance, a member of the set of drive pinion gears 100 may be directly coupled to the drive pinion 50 or indirectly connected to the drive pinion 50 such as via a drive pinion extension 170. The drive pinion 50 may comprise the drive pinion extension 170. For instance, the drive pinion extension 170 may extend from the drive pinion 50 and may be a separate piece that is part of the drive pinion 50. For instance, the drive pinion extension 170 may be attached to the drive pinion 50 and may lengthen the drive pinion 50.

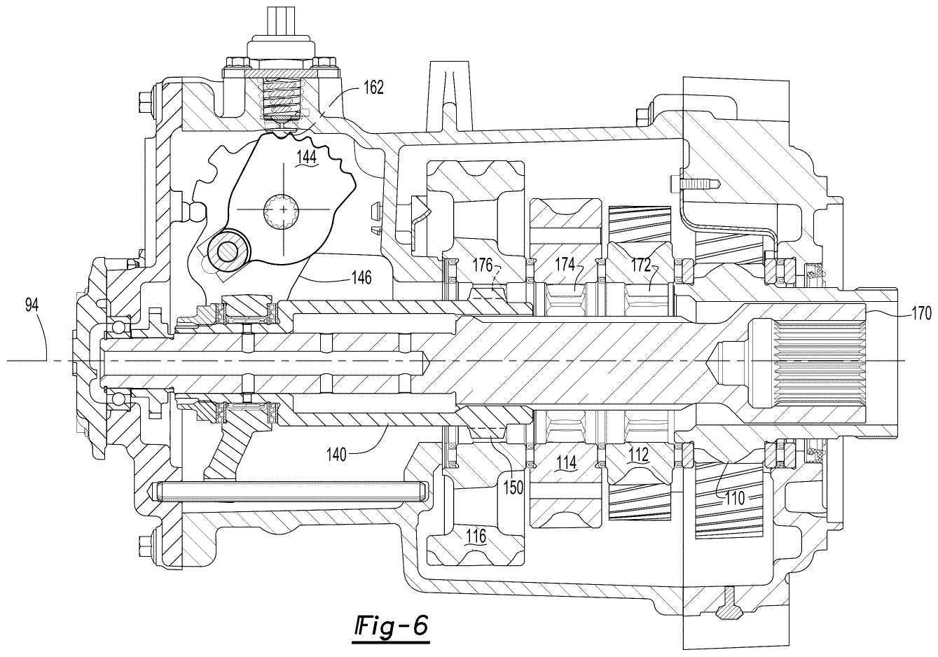

The coupling 140 is in a first position in FIG. 6. In the first position, the coupling 140 couples the fourth gear 116 to the drive pinion 50. For example, the teeth of the coupling gear 150 may mesh with inner gear teeth 176 of the fourth gear 116. Torque may be transmitted from the rotor 92 to the first gear 110, from the first gear 110 to the first countershaft gears 120, 120′, from the first countershaft gears 120, 120′ to the fourth countershaft gears 126, 126′ via the first and second countershafts 106, 106′, respectively, from the fourth countershaft gears 126, 126′ to the fourth gear 116, and from the fourth gear 116 to the drive pinion 50 via the coupling gear 150 of the coupling 140.

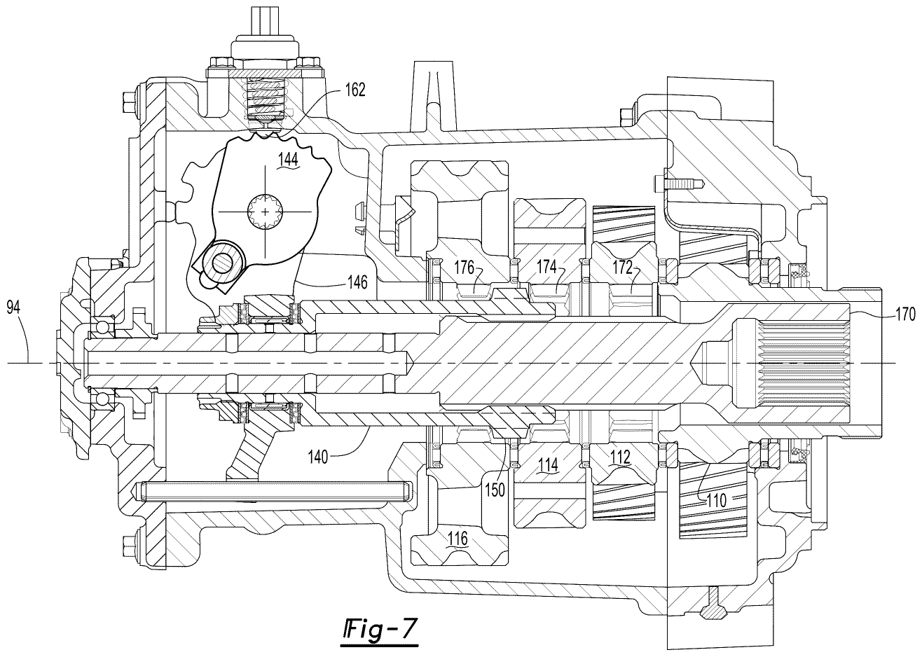

The coupling 140 is in a first neutral position in FIG. 7. In the first neutral position, the coupling 140 does not couple any member of the set of drive pinion gears 100 to the drive pinion 50. As such, the teeth of the coupling gear 150 may be spaced apart from the first gear 110, the second gear 112, the third gear 114, and the fourth gear 116. Torque may not be transmitted between the transmission 48 and the drive pinion 50 in the first neutral position. Thus, the transmission 48 is disconnected from the drive pinion 50 when the coupling is in the first neutral position. The electric motor 46 and the transmission 48 are disconnected from the differential assembly 42 and the axle shafts 44 when the coupling 140 is in the first neutral position.

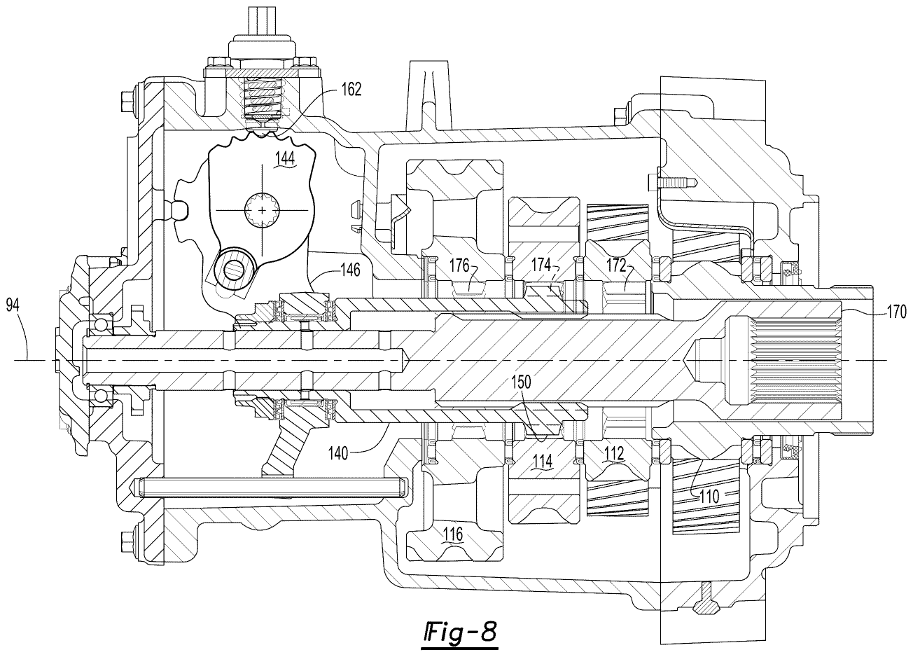

The coupling 140 is in a second position in FIG. 8. In the second position, the coupling 140 couples the third gear 114 to the drive pinion 50. For example, the teeth of the coupling gear 150 may mesh with inner gear teeth 174 of the third gear 114. Torque may be transmitted from the rotor 92 to the first gear 110, from the first gear 110 to the first countershaft gears 120, 120′, from the first countershaft gears 120, 120′ to the third countershaft gears 124, 124′ via the first and second countershafts 106, 106′, respectively, from the third countershaft gears 124, 124′ to the third gear 114, and from the third gear 114 to the drive pinion 50 via the coupling gear 150 of the coupling 140.

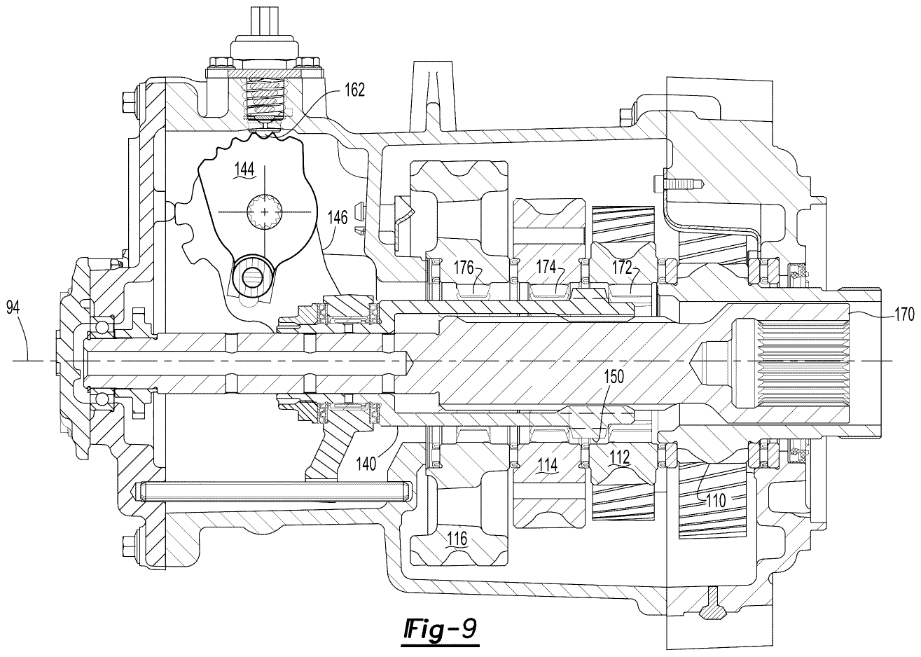

The coupling 140 is in a second neutral position in FIG. 9. In the second neutral position, the coupling 140 does not couple any member of the set of drive pinion gears 100 to the drive pinion 50. As such, the teeth of the coupling gear 150 are spaced apart from the first gear 110, the second gear 112, the third gear 114, and the fourth gear 116. Torque may not be transmitted between the transmission 48 and the drive pinion 50 in the second neutral position. Thus, the transmission 48 is disconnected from the drive pinion 50 when the coupling is in the second neutral position. The electric motor 46 and the transmission 48 are disconnected from the differential assembly 42 and the axle shafts 44 when the coupling 140 is in the second neutral position.

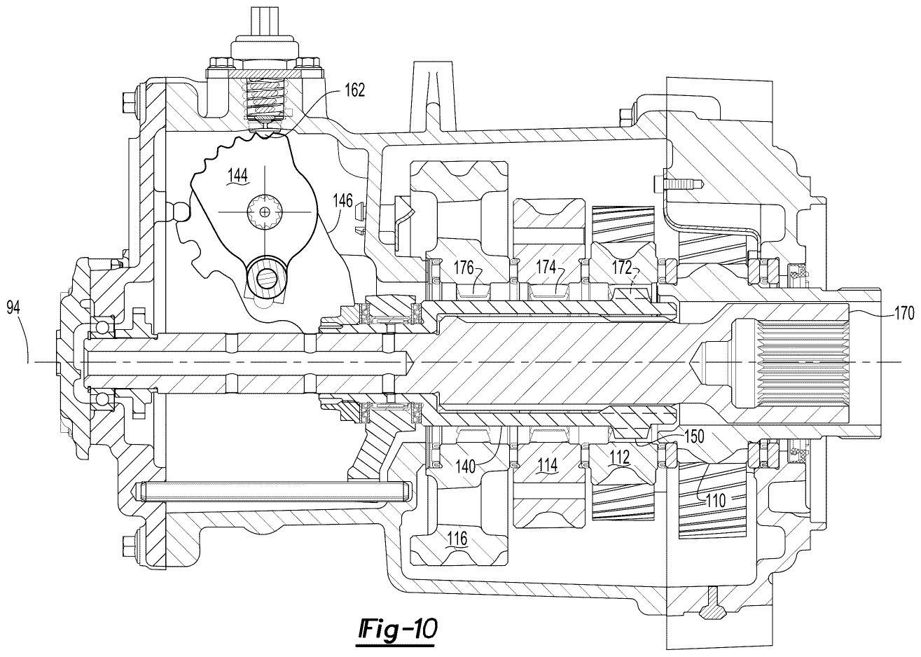

The coupling 140 is in a third position in FIG. 10. In the third position, the coupling 140 couples the second gear 112 to the drive pinion 50. For example, the teeth of the coupling gear 150 may mesh with inner gear teeth 172 of the second gear 112. Torque may be transmitted from the rotor 92 to the first gear 110, from the first gear 110 to the first countershaft gears 120, 120′, from the first countershaft gears 120, 120′ to the second countershaft gears 122, 122′ via the first and second countershafts 106, 106′, respectively, from the second countershaft gears 122, 122′ to the second gear 112, and from the second gear 112 to the drive pinion 50 via the coupling gear 150 of the coupling 140.

Referring to FIG. 1, the drive pinion 50 operatively connects the differential assembly 42 and the transmission 48. The drive pinion 50 may be received in the housing assembly 40 and may transmit torque between the differential assembly 42 and the transmission 48. The drive pinion 50 is rotatable about an axis, such as the axis 94, and may have a gear portion that has teeth that meshes with teeth of the ring gear 70 of the differential assembly 42. Torque that is provided by the electric motor 46 to the transmission 48 and to the drive pinion 50 may be transmitted to the ring gear 70 and thus to the differential assembly 42. The drive pinion 50 may comprise a drive pinion extension 170 as previously mentioned.

Referring to FIG. 1, the wheel disconnect 52, if provided, is configured to couple the differential assembly 42 to a wheel hub 68 and decouple the differential assembly 42 from the wheel hub 68. In some embodiments, the wheel disconnect 52 includes an actuator 180 and a coupling 182. The actuator 180 is configured to actuate or move the coupling 182 between a coupled position and a decoupled position, which is also referred to as a neutral position. In the coupled position, the differential assembly 42 may be directly or indirectly coupled to the wheel hub 68 via the coupling 182 to permit torque to be transferred between the differential assembly 42 and the wheel hub 68. In the decoupled or neutral position, the differential assembly 42 may be decoupled or disconnected from the wheel hub 68 such that torque is not transferrable between the differential assembly 42 and the wheel hub 68. For illustration purposes, the wheel disconnects associated with the front axle assembly 20 are shown in the coupled position while the wheel disconnects 52 associated with the rear axle assembly 20 are shown in the neutral position in FIG. 1.

The coupling 182 may be located at any suitable location. In the example shown, the coupling 182 is positioned between the differential assembly 42 and the wheel hub 68 such that the coupling 182 can couple/decouple a stub shaft of the differential assembly 42 and an axle shaft 44. As such, the stub shaft and the axle shaft 44 may be rotatable together when the coupling 182 is in the coupled position and the axle shaft 44 can rotate with respect to the stub shaft when the coupling 182 is in the neutral position. In such a configuration, torque may not be transferred between the differential assembly 42 and the axle shaft 44 when the coupling 182 is in the neutral position.

As another example, the coupling 182 may also be positioned closer to the wheel hub 68, such as between the wheel hub 68 and the axle shaft 44. The wheel hub 68 and the axle shaft 44 may be rotatable together when the coupling 182 is in the coupled position and the axle shaft 44 can rotate with respect to the wheel hub 68 when the coupling 182 is in the neutral position. In such a configuration, torque may not be transferred between the wheel hub 68 and the axle shaft 44 when the coupling 182 is in the neutral position.

Regardless of where the coupling 182 is located, moving the coupling to the neutral position not only disconnects the wheel hub 68 from the differential assembly 42, but also disconnects the electric motor 46 and the transmission 48 from the wheel hub 68. Thus, rotation of the wheel hub 68 does not cause rotation of the differential assembly 42, the electric motor 46 and the transmission 48.

The electric energy system 30 is disposed on the vehicle 10. The electric energy system 30 is configured to store and supply electrical energy. Electrical energy may be stored in the first electric power source 32 and the second electric power source 34. Electrical energy may be provided to the electric energy system 30 to charge the first electric power source 32, the second electric power source 34, or both. For example, electrical energy may be provided to the electric energy system 30 when the electric motor 46 is operating as a generator.

The first electric power source 32 is configured to provide electrical energy to propel the vehicle 10. The first electric power source 32, which may also be referred to as a traction battery or an energy storage system (ESS), may be a high-voltage power source that may include a plurality of electrical energy storage devices, such as battery cells, capacitors, or the like. The first electric power source 32 may have a higher storage capacity than the second electric power source 34.

The second electric power source 34 is configured to provide electrical energy for non-propulsion functions. Examples of non-propulsion functions may include vehicle startup, vehicle systems monitoring, vehicle access, lighting, audio system, and the like. The second electric power source 34, which may be referred to as a low-voltage power source or low-voltage battery, may be a low-voltage power source that may have a lower voltage capacity or provide a lower voltage of electrical energy than the first electric power source 32. As a nonlimiting example, the second electric power source 34 may be a battery, including but not limited to a nominally rated 12V battery. The second electric power source 34 may be electrically connectable to the first electric power source 32 via a DC/DC connection.

The control system 36 is provided with the vehicle 10. The control system 36 controls operation of one or more axle assemblies 20. For example, the control system 36 may include one or more microprocessor-based control modules or controllers 190 that may be electrically connected to or communicate with components of the vehicle 10 and/or the axle assembly 20, such as the electric motor 46, the inverter 80, the actuator 180, etc.

Control system connections are represented by the double arrowed lines associated with the controller 190 in FIG. 1 as well as by connection symbol A. Control system connections may represent electrical connections for communication and control, electrical connections to provide power, or both. The control system 36 may also monitor and control the electric energy system 30.

The control system 36 may also process input signals or data from various input devices or sensors. These input devices may include an operator communication device 200, a wheel speed sensor 202, an inverter temperature sensor 204, a stator temperature sensor 206, and a rotor temperature sensor 208. an accelerator pedal position sensor 210, a first speed sensor 212, a second speed sensor 214, a coupling position sensor 216, or combinations thereof.

The operator communication device 200 facilitates communication with an operator. In some configurations, the operator communication device 200 may receive an input from an operator or vehicle driver and/or provide information to an operator. The operator communication device 200 may be of any suitable type. For instance, the operator communication device 200 may provide visual communication, such as a display, light, screen, touchpad or the like, may provide audible communication such as a sound or spoken language message, may provide haptic feedback such as vibration that may be felt by an operator, or combinations thereof. The operator communication device 200 may be configured to provide information to the operator, such as a notification or alert.

A wheel speed sensor 202 provides a signal indicative of the rotational speed or rotational velocity of a wheel assembly 22. For instance, the wheel speed sensor 202 may provide a signal indicative of the rotational speed or rotational velocity of a wheel assembly 22 and an associated axle shaft 44. The signal from the wheel speed sensor 202 may also be indicative of the acceleration of a wheel assembly 22 and an associated axle shaft 44 when measured over time since acceleration is the rate of change in velocity or change in velocity divided by the change in time. In at least one configuration, the wheel speed sensor 202 may be mounted to the axle assembly 20 and may detect rotation of a wheel hub 68 upon which the wheel assembly 22 is mounted and thus may be indicative of wheel speed. Alternatively or in addition, a wheel speed sensor 202 may detect rotation of an axle shaft 44. In some configurations, wheel speed sensors are provided with each axle assembly 20 and are associated with each wheel hub 68.

The inverter temperature sensor 204 provides a signal indicative of the temperature of an inverter 80. An inverter temperature sensor 204 may be provided with each inverter 80 when multiple inverters are provided with the drive axle system 12. In FIG. 1, the inverter temperature sensor 204 is illustrated as being located adjacent to the inverter 80 for clarity; however, the inverter temperature sensor 204 may be located inside or outside of the inverter 80. The inverter temperature sensor 204 may directly or indirectly detect the temperature of the inverter 80. For instance, inverter temperature sensor 204 may directly detect the inverter temperature, such as when the inverter temperature sensor 204 is disposed on or integrated with the inverter 80. The inverter temperature sensor 204 may indirectly detect the inverter temperature by detecting the temperature of coolant that circulates through the inverter 80 or through a coolant jacket or other heat exchanger to cool the inverter 80. It is also contemplated that the temperature of the inverter 80 may be estimated by a controller of the control system 36 rather than directly measured or detected. Thus, the term inverter temperature sensor as used herein encompasses directly detecting inverter temperature, detecting inverter temperature indirectly, and estimating the inverter temperature.

The stator temperature sensor 206 provides a signal indicative of the temperature of the stator 90 of the electric motor 46. In FIG. 1, the stator temperature sensor 206 is illustrated as being located outside of the electric motor 46 for clarity; however, the stator temperature sensor 206 may be located inside the electric motor 46 adjacent to or within the stator 90. The stator temperature sensor 206 may directly or indirectly detect the temperature of the stator 90. For instance, stator temperature sensor 206 may directly detect the stator temperature, such as when the stator temperature sensor 206 is disposed on or integrated with the stator 90. The stator temperature sensor 206 may indirectly detect the stator temperature by detecting the temperature of coolant that circulates through a coolant jacket that cools the stator 90. It is also contemplated that the temperature of the stator 90 may be estimated by a controller of the control system 36 rather than directly measured or detected. Thus, the term stator temperature sensor as used herein encompasses directly detecting stator temperature, detecting stator temperature indirectly, and estimating the stator temperature.

The rotor temperature sensor 208 provides a signal indicative of the temperature of the rotor 92 of the electric motor 46. In FIG. 1, the rotor temperature sensor 208 is illustrated as being located outside of the electric motor 46 for clarity; however, the rotor temperature sensor 208 may be located inside the electric motor 46 adjacent to or within the rotor 92. It is also contemplated that the temperature of the rotor 92 may be estimated by a controller of the control system 36 rather than directly measured or detected. Thus, the term rotor temperature sensor as used herein encompasses directly detecting rotor temperature, detecting rotor temperature indirectly, and estimating the rotor temperature.

The accelerator pedal position sensor 210 provides a signal that is indicative of the position of an accelerator pedal. For example, the accelerator pedal position sensor 210 may provide a signal that is indicative of a request for acceleration the vehicle 10. The signal provided by the accelerator pedal position sensor 210 is referred to as a torque request signal and may be used by a controller of the control system 36 as in input that is used control the torque that is provided by an electric motor 46. For instance, the controller of the control system 36 may control the electric motor 46 to provide propulsion torque or regeneration torque based on the torque request signal from the accelerator pedal position sensor 210. It is also contemplated that an autonomous driving system or a vehicle cruise control system may provide the torque request signal.

The accelerator pedal may be operated or actuated by a driver or operator of the vehicle 10 to request acceleration and deceleration of the vehicle 10. The accelerator pedal may have any suitable configuration. For example, the accelerator pedal may be a foot-operated pedal that may be mounted near the floor of the passenger compartment of the vehicle 10 or may be a hand-operated pedal that may be provided in another location, such as proximate a steering wheel or control console of the vehicle 10.

The accelerator pedal may be moveable between a first position and a second position. The first position may be a released position in which the accelerator pedal is not actuated or depressed by the driver. The first position may correspond with a 0% pedal position when expressed as a percentage. The second position may be a fully actuated or “full throttle” position in which the accelerator pedal is actuated or depressed by the driver to its fullest extent. The second position may correspond with a 100% pedal position when expressed as a percentage. The pedal may also be actuated to multiple intermediate positions between the first position and the second position. These intermediate positions may correspond to pedal positions that are greater than 0% and less than 100% when expressed as a percentage.

It is also contemplated that a single pedal may provide a signal or signals indicative of a request for positive acceleration or a request for negative acceleration (i.e., deceleration) rather than separate accelerator and brake pedals. Such a configuration in referred to as a “one-pedal” driving system. Thus, the term accelerator pedal also encompasses one-pedal driving system in which a single pedal can be used to request acceleration and deceleration of the vehicle.

The first speed sensor 212 may detect or provide a signal indicative of the rotational speed or rotational velocity of a rotatable component disposed upstream from the coupling 140 such as the rotor 92 or a gear of the transmission 48.

The second speed sensor 214 may detect or provide a signal indicative of the rotational speed or rotational velocity of the coupling 140 or a rotatable component disposed downstream from the coupling 140, such as the drive pinion 50, the differential assembly 42, an axle shaft 44, a wheel hub 68 or the like. The first speed sensor 212 and the second speed sensor 214 may be used in conjunction to determine when the rotational speed of the coupling 140 is sufficiently synchronized with the rotational speed of another component, such as a transmission gear, to permit movement or shifting of the coupling 140. Accordingly, the terms “synchronized” or “sufficiently synchronized” mean that the rotational speed of two components may be sufficiently close so as to permit the coupling 140 to be shifted and may not require exactly the same rotational speed.

The coupling position sensor 216 is configured to provide a signal or data indicative of the position of the coupling 140. For instance, the signal may be indicative as to whether the coupling 140 is in a neutral position or is positioned to engage a gear of the transmission 48. The coupling position sensor 216 may directly or indirectly detect or generate a signal indicative of the position of the coupling 140. For instance, the coupling position sensor 216 may be a proximity sensor or the like that may directly detect the position of the coupling 140. Alternatively, the coupling position sensor 216 may indirectly detect the position of the coupling 140, such as by detecting the stroke or actuation distance of the actuator 142 or number of revolutions of a shaft of the actuator 142 when the actuator 142 is configured to rotate to actuate the coupling 140. In such a configuration, the signal may be provided by the actuator 142 or may be based on an operating attribute of the actuator 142.

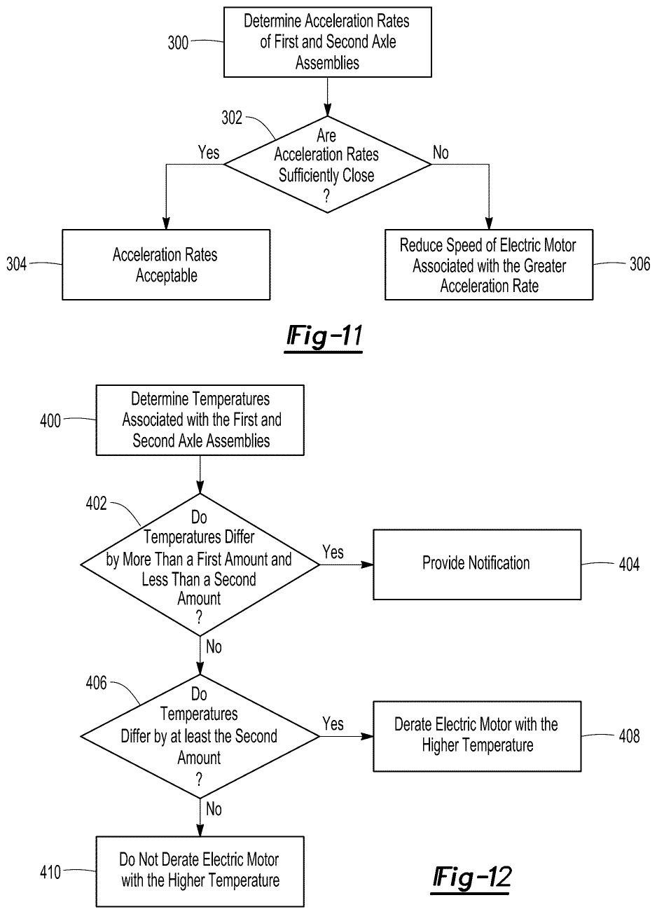

Referring to FIGS. 11-15, flowcharts associated with a method or methods of controlling an axle assembly, drive axle system, or a vehicle having an axle assembly is shown. As will be appreciated by one of ordinary skill in the art, the flowcharts may represent control logic which may be implemented or affected in hardware, software, or a combination of hardware and software. For example, the various functions may be affected by a programmed microprocessor, such as may be provided with the control system 36. The control logic may be implemented using any of a number of known programming and processing techniques or strategies and is not limited to the order or sequence illustrated. For instance, interrupt or event-driven processing may be employed in real-time control applications rather than a purely sequential strategy as illustrated. Likewise, parallel processing, multitasking, or multi-threaded systems and methods may be used.

Control logic may be independent of the particular programming language, operating system, processor, or circuitry used to develop and/or implement the control logic illustrated. Likewise, depending upon the particular programming language and processing strategy, various functions may be performed in the sequence illustrated, at substantially the same time, or in a different sequence while accomplishing the method of control. The illustrated functions may be modified, or in some cases omitted, without departing from the scope of the present invention. Method steps may be executed by the control system 36. Method steps may be implemented as a closed loop control system.

It is to be understood that the methods depicted in FIGS. 11-15 may be performed separately or in any combination. For instance, the control system 36 may execute method steps of one or more of the methods disclosed.

Referring to FIG. 11, a flowchart of a first method of control is shown. The first method may be employed with a drive axle system having multiple axle assemblies and that have multiple electric motors.

As an overview, a drive axle system may include an interaxle differential unit when multiple axle assemblies are mechanically connected in series. The interaxle differential unit is a mechanical power divider that distributes power between the axle assemblies and accommodates or compensates for rotational speed differences between different drive axle assemblies, such as speed differences between a first axle assembly and a second axle assembly that is connected in series with the first axle assembly. Thus, wheels of the first axle assembly can operate or rotate at a different speed than the wheels of the second axle assembly when permitted by the interaxle differential unit. In a tandem axle configuration, the interaxle differential unit may be connected to an output or output shaft of the first axle assembly and an input or input shaft of the second axle assembly, and thus may allow the input and output to rotate at different speeds when the interaxle differential unit is unlocked. The interaxle differential unit may be locked to make the input and output rotate at the same speed. Locking the interaxle differentia unit may be desirable wheel slip is detected to prevent torque from being directed along a path of least resistance to a slipping wheel and away from wheels that are not slipping. Wheel slip can result in reduced vehicle traction to propel the vehicle, increased rates of rotation of associated components, and potential wear.

A drive axle system that has multiple axle assemblies that incorporate electric motors for propulsion may not be mechanically connected in series. As a result, there is no mechanical connection that transmits torque from one axle assembly to another axle assembly and no mechanical interaxle differential unit. As a result, it is possible that each axle assembly may be operated independently, which may result in uncoordinated operation of the axle assemblies and may not adequately address wheel slip conditions.

The method associated with FIG. 11 helps address wheel slip associated with axle assemblies that incorporate electric motors for propulsion by providing interaxle differential unit functionality via software or a method of control rather than via a mechanical torque path connection. The method is described below primarily in the context of a drive axle system having two axle assemblies that each have an electric motor; however, it is contemplated that the method may be employed with more than two axle assemblies.

At block 300, the acceleration (e.g., rate of acceleration, acceleration rate) associated with each axle assembly 20 is determined. Data indicative of acceleration may be provided by wheel speed sensors 202 associated with each axle assembly 20. In some configurations, wheel speed sensors 202 are associated with each wheel hub 68 of an axle assembly (e.g., first and second wheel speed sensors 202 provide signals indicative of the rotational speed or rotational velocity of the first and second wheel ends 68, respectively) and the rate of acceleration of the axle assembly is designated as the larger value (e.g., the rate of acceleration of the axle assembly is designated as the rate of acceleration of the first wheel end when the acceleration rate of the first wheel end exceeds the acceleration rate of the second wheel end or vice versa). In some configurations, the rate of acceleration of an axle assembly is designated as the average acceleration of both wheel hubs 68 (e.g., the acceleration rate of both wheel hubs of the axle assembly over a predetermined or constant time interval is determined, then averaged, and the average is designated as the rate of acceleration of the axle assembly).

At block 302, the acceleration rates associated with each axle assembly are compared. For instance, the acceleration rate associated with the first axle assembly and the acceleration rate associated with the second axle assembly are compared to determine whether the acceleration rates are sufficiently close to each other. The acceleration rates may be sufficiently close when the acceleration rate of the first axle assembly is within a predetermined amount or predetermined percentage of the acceleration rate of the second axle assembly. The predetermined amount or predetermined percentage may be based on vehicle development testing and may be an amount or percentage that is indicative of wheel slip having a sufficient magnitude and/or duration. As a non-limiting example, acceleration rates of the first and second axle assemblies may be sufficiently close when the acceleration rate of the first axle assembly is no more than 30% greater than or less than the acceleration rate of the second axle assembly. If the acceleration rates are sufficiently close, then the method continues at block 304. If the acceleration rates are not sufficiently close, then the method continues at block 306.

At block 304, the acceleration rates are sufficiently close. Sufficiently close acceleration rates may be indicative that there is no wheel slip or that wheel slip is present but has a magnitude or duration that is not believed to have a meaningful effect on traction or driving of the vehicle. Thus, actions to mitigate wheel slip, such as reducing the speed of an electric motor, are not performed.

At block 306, the acceleration rates are not sufficiently close. Acceleration rates that are not sufficiently close may indicate that wheel slip is present and has a magnitude or duration that may affect traction or driving characteristics. The speed of the electric motor of the axle assembly that has the larger acceleration rate or that is experiencing faster acceleration is reduced. In some configurations, the speed of the electric motor of the axle assembly that has the larger acceleration rate is reduced until the accelerations rates of the first and second axle assemblies match. In some configurations, the method is executed iteratively or as a loop and the speed of the electric motor of the axle assembly that has the larger acceleration rate is reduced by a predetermined reduction amount (e.g., 5%, 10%, 15%) until the acceleration rates are sufficiently close. For instance, the speed of the electric motor may be reduced by a predetermined reduction amount of 5% and then reevaluated to see if the acceleration rates are sufficiently close. If the acceleration rates are not sufficiently close, then the speed of the electric motor may be reduced by another 5% and so on. As a result, the speed of the electric motor may be reduced to limit or stop spinning of a wheel and reduce or decrease energy consumption that is being directed to a slipping wheel rather than propulsion of the vehicle.

Referring to FIG. 12, a flowchart of a second method of control is shown. As an overview, the method may be employed with a drive axle system having multiple axle assemblies that each have an associated electric motor. The electric motors may be electrically connectable to the same traction battery (e.g., the same first electric power source 32) or may be electrically connectable to dedicated traction batteries (e.g., different first electric power sources).

In such drive axle systems, it is expected that the temperatures of the electric motors of each axle assembly will be relatively close and the temperatures of the inverters of each axle assembly will be relatively close during normal operation (e.g., when both axle assemblies provide propulsion torque, such as when propulsion torque is split relatively evenly between the axle assemblies). If the temperatures of the stators, the rotors, the inverters, or combinations thereof are not sufficiently close, then this could be indicative of a thermal management issue, such as a leak in the coolant system for an electric motor or an inverter, insufficient coolant pressure or flow rate, such as due to a coolant pump malfunction or blockage, a coolant temperature or heat transfer issue, such as insufficient thermal energy transfer from the coolant due to a heat exchanger fan malfunction, or the like. If one or more of the stator temperatures, the rotor temperatures, the inverter temperatures, are not sufficiently close, then a vehicle operator may be alerted or actions may be taken to derate an electric motor.

The method associated with FIG. 12 is primarily described below in the context of a drive axle system having a first axle assembly and a second axle assembly. It is contemplated that the method may also be employed with a drive axle system having additional axle assemblies.

At block 400, the method determines temperatures associated with the axle assemblies.

Temperatures associated with the first axle assembly may include one or more of a temperature of the inverter 80 that is electrically connected to the first axle assembly, which is referred to as a first inverter temperature, a temperature of the stator 90 of the electric motor 46 of the first axle assembly, which is referred to as a first stator temperature, and a temperature of the rotor 92 of the electric motor 46 of the first axle assembly, which is referred to as a first rotor temperature. A signal or data indicative of the first inverter temperature may be provided by a first inverter temperature sensor 204. A signal or data indicative of the first stator temperature may be provided by a first stator temperature sensor 206. A signal or data indicative of the first rotor temperature may be provided by a first rotor temperature sensor 208.

Temperatures associated with the second axle assembly may include one or more of a temperature of the inverter 80 that is electrically connected to the second axle assembly, which is referred to as a second inverter temperature, a temperature of the stator 90 of the electric motor 46 of the second axle assembly, which is referred to as a second stator temperature, and a temperature of the rotor 92 of the electric motor 46 of the second axle assembly, which is referred to as a second rotor temperature. A signal or data indicative of the second inverter temperature may be provided by a second inverter temperature sensor 204. A signal or data indicative of the second stator temperature may be provided by a second stator temperature sensor 206. A signal or data indicative of the second rotor temperature may be provided by a second rotor temperature sensor 208.

At block 402, the method determines whether the temperatures differ by more than a first amount and less than a second amount.

In some configurations, only inverter temperatures are compared. In some configurations, only stator temperatures are compared. In some configurations, only rotor temperatures are compared. In some configurations, temperatures are compared for multiple corresponding components, such as comparing inverter temperatures as well as comparing stator temperatures and/or rotor temperatures, or comparing stator temperatures as well as rotor temperatures, or comparing inverter temperatures as well as stator temperatures as well as inverter temperatures.

The first amount and the second amount may be based on vehicle development testing. The first amount is less than the second amount. The first amount and the second amount may be constant values or variable. As a non-limiting example, the first amount may be 3 °C and the second amount may be 6 °C. In some configurations, the temperatures that are compared are temperatures of corresponding components, such as the first and second inverter temperatures, the first and second stator temperatures, and the first and second rotor temperatures.

Using inverter temperatures as an example, the method may determine how much the first inverter temperature and the second inverter temperature differ from each other and then compare the difference or absolute value of the difference to the first amount associated with the inverter and the second amount associated with the inverter. For example, if the first inverter temperature and second inverter temperature differ by 5 °C, then this difference is greater than the first amount and less than the second amount when the first amount is 3 °C and the second amount is 6 °C

Using stator temperatures as an example, the method may determine how much the first stator temperature and the second stator temperature differ from each other and then compare the difference or absolute value of the difference to the first amount associated with the stator and the second amount associated with the stator. For example, if the first stator temperature and second stator temperature differ by 4 °C, then this difference is greater than the first amount and less than the second amount when the first amount is 3 °C and the second amount is 6 °C.

Using rotor temperatures as an example, the method may determine how much the first rotor temperature and the second rotor temperature differ from each other and then compare the difference or absolute value of the difference to the first amount associated with the rotor and the second amount associated with the rotor. For example, if the first rotor temperature and second rotor temperature differ by 4.5 °C, then this difference is greater than the first amount and less than the second amount when the first amount is 3 °C and the second amount is 6 °C.

It is contemplated that the first and second amounts associated with the inverter, stator, and rotor temperatures may be the same (as in the examples above) or may be different. As some non-limiting examples of different first and second amounts, the first and second amounts associated with the inverter may be 4 °C and 8 °C, respectively, the first and second amounts associated with the stator may be 3 °C and 6 °C, respectively, and the first and second amounts associated with the rotor may be 4 °C and 7 °C, respectively.

If the compared temperatures differ by more than a first amount and less than a second amount, then the method continues at block 404. If the compared temperatures do not differ by more than a first amount and less than a second amount, then the method continues at block 406.

At block 404, a notification is provided. The notification may indicate that a temperature is elevated and may optionally specify the components or components associated with the elevated temperatures. (i.e., specify which component has the higher temperature). The notification may be provided to and operator via the operator communication device 200. The notification may be of any suitable type. For instance, the notification may be a visual notification, audible notification, haptic notification, or combinations thereof.

At block 406, the method determines whether the compared temperatures differ by at least the second amount (e.g., differ by the second amount or more than the second amount). If the temperatures differ by more than the second amount, then the method continues at block 408. If the temperatures do not differ by more than the second amount, then the method continues at block 410.

At block 408, the electric motor or electric motor torque of the electric motor having the higher temperature is derated. Derating may be based on the stator temperature, the rotor temperature, the inverter temperature or combinations thereof. In some configurations, the electric motor is derated when the first and second inverter temperatures differ by at least the second amount associated with the inverter temperature comparison. In some configurations, the electric motor is derated when the first and second stator temperatures differ by at least the second amount associated with the stator temperature comparison. In some configurations, the electric motor is derated when the first and second rotor temperatures differ by at least the second amount associated with the rotor temperature comparison. In some configurations, the electric motor is derated when at least two of (a) the first and second inverter temperatures, (b) the first and second stator temperatures, and (c) the first and second rotor temperature differ by at least the second amount associated with the associated temperature comparison.

Derating may be based on a temperature that exceeds the second amount. In some configurations, the stator temperature, the rotor temperature, or the inverter temperature may be used individually to reference a corresponding derating value from an array of derating values that are stored in a lookup table. In some configurations, two or more of the stator temperature, the rotor temperature, and the inverter temperature may be used in combination to reference a corresponding derating value from an array of derating values that are stored in a lookup table. The lookup table may be populated with derating values based on vehicle development testing or drive axle system development testing. The derating value may be expressed as a percentage. For example, the derating value obtained from the lookup table may be expressed as a percentage, such as 15%. This derating value may be applied to the peak available torque of the electric motor, the continuous torque of the electric motor, or both to derate or limit the peak available torque and the continuous torque (e.g., the peak available torque may be reduced by 15% and the continuous torque may be reduced by 15%) that can be provided by the electric motor having the higher associated temperature. The peak available torque and/or the continuous torque may be derated to attempt to avoid additional temperature increases that may result in one or more of the stator 90, the rotor 92, and the inverter 80 from increasing in temperature to allow the temperature of one or more of the stator 90, the rotor 92, and the inverter 80 to stabilize or decrease. Thus, the torque command from a vehicle operator is derated (e.g., capped, limited) so as not to exceed the derated peak available torque (e.g., the peak available torque reduced by 15%) or the derated continuous torque (e.g., the continuous torque reduced by 15%) to attempt to avoid further temperature increases of the stator 90, the rotor 92, or the inverter 80. Derating may result in providing less torque than requested by the vehicle driver and thus less torque than the torque request associated with the torque request signal from the accelerator pedal position sensor 210. The electric motor 46 may be operated to provide torque to a wheel assembly 22 based on the torque command.

At block 410, the electric motor or electric motor torque is not derated. This block is reached when the temperatures differ by not more than the first amount (e.g., differ by the first amount or less than the first amount). As such, the temperatures are deemed to be sufficiently close so that a notification is not provided to the operator and the electric motors are not derated due to an elevated temperature.

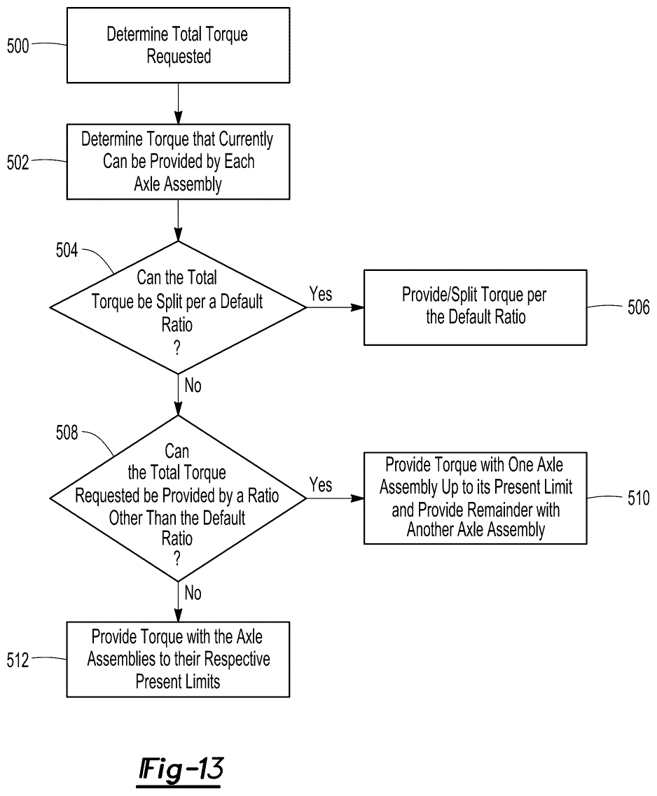

Referring to FIG. 13, a flowchart of a third method of control is shown. This method may be employed to control torque distribution in drive axle system comprising multiple axle assemblies.

As an overview, torque requested by a vehicle operator can be split or distributed between multiple drive axle assemblies in a drive axle system having multiple axle assemblies. For instance, in a tandem axle configuration having two axle assemblies with dedicated electric motors, the torque requested, such as propulsion torque, can be split between the two axle assemblies at a default or predetermined ratio, such as a 50%/50% split in which each axle assembly provides half of the torque that is requested. The predetermined split may be provided when a gear shift is not being executed.

In some situations, the requested torque cannot be split using the default or predetermined ratio, such as when the torque output of one or both axle assemblies is limited. Torque output may be limited by various factors, such as the temperature of an inverter associated with the axle assembly or the temperature of the electric motor associated with the axle assembly (e.g., the temperature of the stator or the temperature of the rotor of the electric motor). For example, output torque may be limited when the inverter temperature is elevated, the stator temperature is elevated, the rotor temperature is elevated, or combinations thereof. If the torque output of one axle assembly is limited, the other axle assembly may be able to provide the remainder of the torque that is requested, such as by not splitting the torque using the default ratio. If the torque output of both axle assemblies is limited, then the axle assemblies may or may not be able to provide the torque requested by not splitting the torque using the default ratio. If the axle assemblies are not able to provide the torque requested when operated together, then some torque may still be provided, such as to help propel the vehicle, but the total torque that is output or provided will be less than requested by the vehicle operator. This limited torque may provide “limp home” functionality in which the vehicle can be driven, but at a lower speed or with less torque than requested by the vehicle operator.

An electric motor can provide a continuous torque and a peak torque. The continuous torque is the maximum amount of torque that the electric motor 46 can produce at a given speed for a long duration or an indefinite period of time. The continuous torque that is available decreases gradually as the speed of the electric motor increases. The peak torque is the highest amount of torque that the electric motor can produce at a given speed for a short duration or a limited period of time, which may typically be less than one second and may be measured in milliseconds. The peak torque may not be constant at all motor speeds. For instance, the peak torque may be constant at low electric motor speeds and may then decrease at higher electric motor speeds after reaching an inflection point. The peak torque is greater than the continuous torque. However, the peak torque can only be provided for relatively short periods of time because providing the peak torque may increase the temperature of the inverter 80, the stator 90 of the electric motor 46, the rotor 92 of the electric motor 46, or combinations thereof. Increased temperature of one or more of these components may reduce or affect the electric motor output torque that can be provided.

As an example for the inverter, a first inverter temperature threshold may be 75 °C, a second inverter temperature threshold may be 90 °C, a maximum available torque that can be provided with the electric motor 46 is the peak torque when the inverter temperature does not exceed 75 °C, the maximum available torque that can be provided with the electric motor 46 is the continuous torque when the inverter temperature is 90 °C, and the maximum available torque may be between the peak torque and the continuous torque when the inverter temperature is between 75 °C and 90 °C. In some configurations, the maximum available torque may decrease in a non-linear manner between 75 °C and 90 °C and may be determined using a lookup table that associates available torque values with the inverter temperature. In some configurations, the maximum available torque may decrease from the continuous torque in a linear manner above 90 °C and may be determined using a lookup table that associates available torque values with the inverter temperature.

As an example for the stator, the first stator temperature threshold may be 130 °C, the second stator temperature threshold may be 185 °C, the maximum available torque that can be provided with the electric motor 46 is the peak torque when the stator temperature does not exceed 130 °C, the maximum available torque that can be provided with the electric motor 46 is the continuous torque when the stator temperature is 185 °C, and the maximum available torque may be between the peak torque and the continuous torque when the stator temperature is between 130 °C and 185 °C. In some configurations, the maximum available torque may decrease in a non-linear manner between 130 °C and 185 °C and may be determined using a lookup table that associates available torque values with the stator temperature. In some configurations, the maximum available torque may decrease from the continuous torque in a linear manner above 185 °C and may be determined using a lookup table that associates available torque values with the stator temperature.

As an example for the rotor, the first rotor temperature threshold may be 100 °C, the second rotor temperature threshold may be 130 °C, the maximum available torque that can be provided with the electric motor 46 is the peak torque when the rotor temperature does not exceed 100 °C, the maximum available torque that can be provided with the electric motor 46 is the continuous torque when the rotor temperature is 130 °C, and the maximum available torque may be between the peak torque and the continuous torque when the rotor temperature is between 100 °C and 130 °C. In some configurations, the maximum available torque may decrease in a non-linear manner between 100 °C and 130 °C and may be determined using a lookup table that associates available torque values with the rotor temperature. In some configurations, the maximum available torque may decrease from the continuous torque in a linear manner above 130 °C and may be determined using a lookup table that associates available torque values with the rotor temperature.

For simplicity, the method below is described in the content of a drive axle system having two axle assemblies.

At block 500, the method determines the torque requested by the vehicle operator. The torque requested may be based on a signal or data from the accelerator pedal position sensor 210.

At block 502, the method determines the torque that can be provided by each axle assembly, which may be referred to as the maximum available torque. The torque that is provided by each axle assembly may decrease as the temperature of the inverter, stator, and rotor increase as discussed above.

The torque that can currently be provided by an axle assembly may be based on one or more of the inverter temperature, the stator temperature, and the rotor temperature. In some configurations, the torque that can be provided is determined by evaluating the inverter temperature, the stator temperature, and the rotor temperature, and then selecting the amount of torque that can be provided based on the inverter temperature, the stator temperature, and the rotor temperature. In some configurations, the amount of torque or available torque defaults to the continuous torque unless the temperature of the rotor, the stator, or the inverter is above a corresponding second temperature threshold. In some configurations, the available torque is less than the continuous torque when the temperature of the rotor, the stator, or the inverter is above a corresponding second temperature threshold.

As a simplified example used in the discussion below, the first axle assembly can provide 100 units of torque or 100% of the continuous torque when the inverter, stator, and rotor of the first axle assembly are not temperature limited (i.e., when the inverter temperature is less than the second inverter temperature threshold, the stator temperature is less than the second stator temperature threshold, and the rotor temperature is less than the second rotor temperature threshold). The available torque or continuous torque is described in terms of units or as a percentage for simplicity since the ratings or continuous torque output of electric motors can differ. Alternatively, the available torque or continuous torque could be expressed in terms of force such as foot-pounds. Similarly, in the examples below the second axle assembly can provide 100 units of torque or 100% of the continuous torque when the inverter, stator, and rotor of the second axle assembly are not temperature limited (i.e., when the inverter temperature is less than the second inverter temperature threshold, the stator temperature is less than the second stator temperature threshold, and the rotor temperature is less than the second rotor temperature threshold).

At block 504, the method determines whether the total torque requested can be split per a default or standard ratio. The default or standard ratio may be a predetermined torque split or predetermined ratio of what percentage of the total torque requested is provided by the electric motor of the first axle assembly and what percentage of the total torque requested is provided by the electric motor of the second axle assembly. In some configurations, the predetermined ratio is a 50%/50% split between the first axle assembly and the second axle assembly in which each axle assembly provides half of the total torque requested. In some configurations, the predetermined ratio is not evenly split, such as a 40%/60% split.

If the total output torque can be split per the default or standard ratio (e.g., the total torque requested can be provided by splitting the total torque requested between the two axle assemblies per the default ratio), then the method may continue at block 506. If the total output torque cannot be split per the default or standard ratio (e.g., splitting the total torque between the two axle assemblies per the default ratio would result in providing less than the total torque requested because at least one axle assembly is temperature limited and cannot currently provide the continuous torque since a second temperature threshold of at least one of its corresponding inverter, stator, or rotor has been exceeded), then the method may continue at block 508.

At block 506, torque is provided or output by the axle assemblies in accordance with the default or standard ratio. For example, half of the output torque or torque requested is provided using the electric motor of the first axle assembly and the other half of the output torque or torque requested is provided by the electric motor of the second axle assembly when the predetermined ratio is a 50%/50% split.

As an example using a predetermined ratio is a 50%/50% split, if a total torque of 80 units is requested, the first axle assembly is not temperature limited and can provided 100 units of torque, and the second axle assembly is not temperature limited and can provide 100 units of torque, then torque can be split evenly between the two axle assemblies with both axle assemblies providing 40 units of torque.

At block 508, the method determines whether the total torque requested can be provided by the axle assemblies at a ratio other than the default or standard ratio. If the total torque requested can be provided by a ratio other than the default or standard ratio, then the method continues at block 510. If the total torque requested cannot be provided by a ratio other than the default or standard ratio, then the method continues at block 512.

At block 510, at least one of the axle assemblies is temperature limited but the total torque requested can still be provided if the torque is split between the axle assemblies at a ratio other than the default or standard ratio. Torque is provided with the electric motors of both axle assemblies by providing output torque with the temperature limited axle assembly or axle assembly that can provide the least amount of torque under its current temperature attributes up to its present output torque limit and by providing the remainer of the total torque requested with the other axle assembly.

As a first example using a predetermined ratio is a 50%/50% split, if a total torque of 80 units is requested, the first axle assembly is not temperature limited and can provided 100 units of torque, and the second axle assembly is temperature limited and can provide 35 units of torque, then there is capacity to provide 80 units of torque (100 units+35 units=135 units). However, the requested torque cannot be split evenly between the two axle assemblies (i.e., with both axle assemblies by providing 40 units of torque). In this case, the second axle assembly is operated to provide 35 units of torque and the remainder or remaining 45 units of torque (80 units−35 units=45 units) are provided with the first axle assembly, resulting in approximately a 56%/44% split. This allows the requested torque to be provided and may allow the first axle assembly to provide additional torque if additional torque is requested.

As a second example using a predetermined ratio is a 50%/50% split, if a total torque of 80 units is requested, the first axle assembly is temperature limited and can provide 50 units of torque, and the second axle assembly is temperature limited and can provide 35 units of torque, then there is capacity to provide 80 units of torque (50 units+35 units=85 units). However, the requested torque cannot be split evenly between the two axle assemblies by providing 40 units of torque with each axle assembly. In this case, the second axle assembly (e.g., the more torque-limited axle assembly) is operated to provide 35 units of torque and the remainder or remaining 45 units of torque (80 units−35 units=45 units) are provided with the first axle assembly. This allows the requested torque to be provided and may allow the first axle assembly to provide some additional torque if additional torque is requested.

At block 512, both axle assemblies are temperature limited and the axle assemblies in combination cannot provide the total torque requested by the vehicle operator. As a result, each axle assembly is operated to provide as much torque as is currently permitted under its temperature limits. As an example, if a total torque of 80 units is requested, the first axle assembly is temperature limited and can provide 35 units of torque, and the second axle assembly is temperature limited and can provide 35 units of torque, then torque cannot be split evenly (with a 50%/50% split) with each axle assemblies providing 40 units of torque. Moreover, the total torque that can be provided by both axle assemblies (35 units+35 units=70 units) is less than the total torque requested (80 units). In this case, the first axle assembly is operated to provide 35 units of torque and the second axle assembly is operated to provide 35 units of torque. As a result, less torque is provided than requested by the vehicle operator, but the torque may permit the vehicle to be operated in a torque-limited manner, which may allow the vehicle to reach its destination or a service facility.

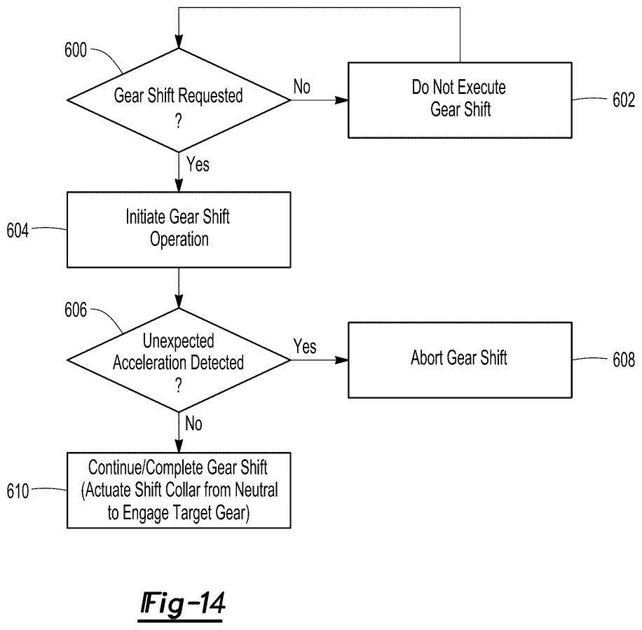

Referring to FIG. 14, a flowchart of a fourth method of control is shown. This method may be employed to control transmission gear shifts in at least one axle assembly of a drive axle system.

As an overview, transmission gear shifts from one gear ratio to another gear ratio may be executed by moving a shift collar or coupling to a transient neutral position in which no gear ratio is engaged, then synchronizing the rotational speed of the coupling with a target gear, such as by changing the rotational speed of the target gear with the electric motor, and then actuating the coupling to engage the target gear. If the coupling is not in a transient neutral position when the electric motor is operated to change the rotational speed of the target gear, then torque will inadvertently or unintentionally be transmitted between the electric motor and the vehicle wheels. This torque may result in unexpected or unintended positive acceleration or negative acceleration (deceleration) of the vehicle. The term acceleration may be used to generically refer to positive acceleration or negative acceleration in the discussion below.

The method determines whether unexpected or unintended positive or negative acceleration occurs or is detected and aborts a gear shift when unexpected or unintended positive or negative acceleration occurs or is detected. In some configurations, the method can supplement or replace directly detecting the position of the shift collar or coupling with a sensor or indirectly detecting the position of the shift collar or coupling based on the movement of the actuator that actuates the shift collar or coupling. It is contemplated that the method can help limit or mitigate unexpected or unintended positive or negative acceleration in the event of a sensor malfunction or communication issue.

At block 600, the method determines whether a gear shift has been requested. A gear shift may be manually requested by a vehicle operator or automatically requested or controlled by the control system 36, such as in an automatic transmission. The gear shift may be a gear upshift to a higher gear (i.e., a higher gear ratio) or a gear downshift to a lower gear (i.e., a lower gear ratio). If a gear upshift has not been requested, then the method iteration may end or a gear shift may not be executed at block 602. If a gear upshift is requested, then the method continues at block 604.

At block 604, a gear shift operation or sequence of actions in preparation for completing a gear shift is initiated. The gear shift operation is primarily described below starting with the transmission being “in gear” or with the coupling 140 positioned to transmit torque with a first gear ratio. Examples of steps associated with initiating the gear shift operation is as follows.

First, the torque provided by the electric motor 46 may be reduced. Reducing the torque may make it easier to actuate the coupling 140. For instance, in the case of a coupling 140 like a shift collar, the reduction in torque may reduce the force that needs to be exerted by the actuator 142 to move a coupling 140 from a position that engages the first gear ratio to a neutral position. In some configurations, this step may be omitted or this step may be omitted when the coupling 140 is already in the neutral position.

Second, the control system 36 commands the coupling 140 to move to a neutral position. Commanding the coupling to move to the neutral position may include controlling or sending a signal to the actuator 142 to move the coupling 140 to disengage a gear of the first gear ratio that is currently engaged by the coupling 140. This may include actuating the coupling 140 toward a target gear of a second gear ratio that is to be engaged next by the coupling 140. The term “commanding” is used to reflect that the actuator 142 may or may not successfully move the coupling 140 to the neutral position and thus may or may not move the coupling 140 by a sufficient amount or distance to disengage the gear of the first gear ratio.

Third, the electric motor 46 is controlled to change the speed of the electric motor 46 in anticipation or preparation for a gear shift. For instance, the speed of the electric motor 46 may be reduced or increased to help synchronize the rotational speed of a target gear or gear of a second gear ratio of the transmission to obtain sufficient synchronization between the rotational speed of the target gear and the rotational speed of the coupling 140 to permit the coupling 140 to be actuated and coupled to the target gear to permit torque to be transmitted via the second gear ratio to the coupling 140.

At block 606, the method determines whether unexpected acceleration (e.g., positive or negative acceleration) is detected. Unexpected acceleration may be detected based on the signal or data from at least one speed sensor, such as the first speed sensor 212 and the second speed sensor 214. If the coupling 140 is still engaged with the gear of the first gear ratio, then a change in speed of the electric motor 46 may be indicated by a corresponding change or proportional change in the speed detected by the second speed sensor 214. As an example, if the electric motor speed is decreased by 10%, the speed of a downstream component may also change by 10% if the coupling 140 remains engaged or vice versa. If the coupling 140 is disengaged from the gear of the first gear ratio, then the rotational speed of the electric motor 46 can change or change at a different rate with respect to the rotational speed of the coupling 140. Therefore, it is expected that changing the speed of the electric motor 46 when the coupling 140 is disengaged from the first gear ratio will result in an increased variance between the speed detected by the first speed sensor 212 and the speed detected by the second speed sensor 214 or an increased or divergent rate of change between the speed detected by the first speed sensor 212 and the second speed sensor 214. If unexpected or unintended acceleration is detected, then the method continues at block 608. If unexpected or unintended acceleration is not detected, then the method continues at block 610.

At block 608, the gear shift is aborted. In some configurations, the gear shift may be aborted by commanding the coupling 140 to move to a neutral position, by changing the speed of the electric motor 46 back to speed immediately before the electric motor 46 was controlled to change its speed in anticipation or preparation for a gear shift, or combinations thereof. In some configurations, the electric motor 46 may temporarily not provide torque, thereby helping prevent unexpected or unintended acceleration. Aborting the shift may also include providing an error signal. The error signal may trigger a notification to the vehicle operator via the operator communication device 200, a diagnostic code to facilitate assessment and maintenance, or both. It is also contemplated that the method iteration may end and another iteration of the method or attempt to complete the gear shift may be made.

At block 610, the method proceeds to attempt to complete the gear shift. At block 610, unexpected or unintended acceleration has not been detected. Therefore, it can be presumed that the coupling 140 is in a neutral position. In some configurations, the rotational speed of the rotor 92 of the electric motor 46 may continue to be adjusted to attempt to match or sufficiently synchronize the rotational speed of the target gear with the rotational speed of the coupling 140 to permit successful movement of the coupling 140 and engagement with the target gear. The controller of the control system 36 may determine whether sufficient synchronization is present based on signals from the first speed sensor 212 and the second speed sensor 214. For example, sufficient synchronization may be present when the speed or velocity indicated by the signal from the first speed sensor 212 is sufficiently close or within a threshold amount or threshold range of the speed or velocity indicated by the signal from the second speed sensor 214. Then, the actuator 142 may be operated to move the coupling 140 into engagement, such as meshing engagement, with the target gear.

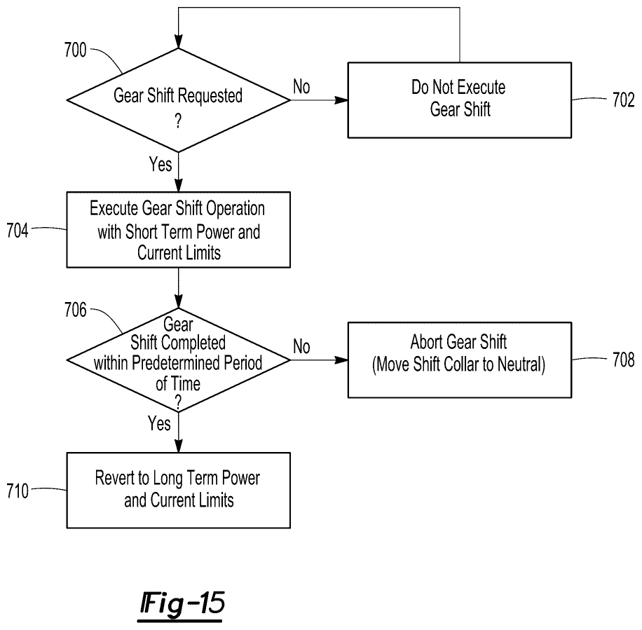

Referring to FIG. 15, a flowchart of a fifth method of control is shown. This method may be employed to control transmission gear shifts in at least one axle assembly of a drive axle system.

As an overview, transmission gear shifts from one gear ratio to another gear ratio may be executed by moving a shift collar or coupling to a transient neutral position in which no gear ratio is engaged, then synchronizing the rotational speed of the coupling with a target gear, such as by changing the rotational speed of the target gear with the electric motor, and then actuating the coupling to engage the target gear. It is desirable to complete a gear shift quickly so that the drive axle system can resume transmitting torque between the electric motor and vehicle wheels to provide propulsion or regeneration torque requested by a driver and reduce latency in providing torque that may affect responsiveness of the drive axle system or that may be negatively perceived by a vehicle driver. Moreover, the period of time or window of time during which sufficient synchronization is present to complete a gear shift may be brief. For instance, the rotational speed of the coupling may not be constant and may change when the vehicle is in motion, such as when the coupling is in a neutral position and is connected to the vehicle wheels. As a result, it may be desirable to rapidly change or adjust the rotational speed of the rotor of the electric motor to synchronize the rotational speed of a target gear with the rotational speed of the coupling or maintain synchronization so that a gear shift can be completed.

The rotational speed of the rotor of the electric motor is limited by power and current limits set for the traction battery or first electric power source 32, such as the long-term power and current limits or normal operating power and current limits set by or recognized the control system 36. Sufficient synchronization could be achieved faster if the traction battery power and current limits are exceeded for a short period of time, which in turn would reduce the time needed to complete a gear shift and may make it more likely that a gear shift can be completed successfully. The present invention permits the long-term power and current limits of the traction battery to be exceeded for a short period of time so that the rotor speed can be changed more rapidly, which thereby more quickly changes the rotational speed of the target gear to be engaged by the coupling, thereby reducing the time to achieve synchronization and the time to complete the shift.

At block 700, the method determines whether a gear shift has been requested. A gear shift may be manually requested by a vehicle operator or automatically requested or controlled by the control system 38, such as in an automatic transmission. The gear shift may be a gear upshift to a higher gear (i.e., a higher gear ratio) or a gear downshift to a lower gear (i.e., a lower gear ratio). If a gear upshift has not been requested, then the method iteration may end or a gear shift may not be executed at block 702. If a gear upshift is requested, then the method continues at block 704.

At block 704, a gear shift operation or sequence of actions taken to execute a gear shift is conducted. The gear shift operation is primarily described below starting with the transmission being “in gear” or with the coupling 140 positioned to transmit torque with a first gear ratio and with the drive axle system operating using the long-term power and current limits of the first electric power source 32. The long-term power and current limits may be the rated limits of the first electric power source 32 or output that can be sustained by the first electric power source 32 without damaging the first electric power source 32. As a non-limiting example, the long-term power limit of the first electrical power source 32 may be 100 kW. It is noted that the method associated with FIG. 14 and the method associated with FIG. 15 may be combined, such as by adding the steps associated with determining and responding to unexpected acceleration (e.g., at block 606) with block 704. Examples of steps associated with executing the gear shift operation are as follows.

First, the torque provided by the electric motor 46 may be reduced. Reducing the torque may make it easier to actuate the coupling 140. For instance, in the case of a coupling 140 like a shift collar, the reduction in torque may reduce the force that needs to be exerted by the actuator 142 to move a coupling 140 from a position that engages the first gear ratio to a neutral position. In some configurations, this step may be omitted or this step may be omitted when the coupling 140 is already in the neutral position.

Second, the control system 36 commands the coupling 140 to move to a neutral position. Commanding the coupling to move to the neutral position may include controlling or sending a signal to the actuator 142 to move the coupling 140 to disengage a gear of the first gear ratio that is currently engaged by the coupling 140. This may include actuating the coupling 140 toward a target gear of a second gear ratio that is to be engaged next by the coupling 140. The term “commanding” is used to reflect that the actuator 142 may or may not successfully move the coupling 140 to the neutral position and thus may or may not move the coupling 140 by a sufficient amount or distance to disengage the gear of the first gear ratio.

Third, temporary or short-term power and current limits for the traction battery or first electric power source 32 are determined and enabled. The short-term power limit and the short-term current limit may be based on performance characteristics of the first electric power source 32. In some configurations, the state of charge of the first electric power source 32 and the temperature of the first electric power source 32 are used to reference a corresponding short-term power limit value and a short-term current limit value from an array of short-term power and current limit value values that are stored in a lookup table. The lookup table may be populated with short-term power and current limit value values based on vehicle development testing or drive axle system development testing. Short-term power and current limits may exceed the rated power and current that can be provided by the first electric power source 32 and may be result in damage to the first electric power source 32 is maintained for more than a predetermined period of time. As a non-limiting example, the predetermined period of time may be less than one second.

Fourth, the electric motor 46 is controlled to change the speed of the electric motor 46 in anticipation or preparation for a gear shift. For instance, the speed of the electric motor 46 may be reduced or increased depending on whether a gear upshift or gear downshift is requested to help synchronize the rotational speed of a target gear or gear of a second gear ratio of the transmission 48.

The speed of the electric motor 46 is controlled using the short-term power limit value and the short-term current limit value. For instance, the rotational speed of the rotor 92 of the electric motor 46 is adjusted using the short-term power limit value and the short-term current limit value to attempt to match or sufficiently synchronize the rotational speed of the target gear with the rotational speed of the coupling 140 to permit the coupling 140 to move and mesh or engage with the target gear. The controller of the control system 36 may determine whether sufficient synchronization is present based on signals from the first speed sensor 212 and the second speed sensor 214. For example, sufficient synchronization may be present when the speed or velocity indicated by the signal from the first speed sensor 212 is sufficiently close or within a threshold amount or threshold range of the speed or velocity indicated by the signal from the second speed sensor 214.

Fifth, the method attempts to complete the gear shift. The actuator 142 may be operated to move the coupling 140 into engagement, such as meshing engagement, with the target gear. As a simplified example, an electric motor may have an operating range of 0-5500 rpm. Providing more power to the electric motor may result in a faster change in its rotational speed. A gear shift may be completed in 0.4 milliseconds when the electric motor is operated at a long-term power limit of 100 kW. However, a gear shift may be completed in 0.2 milliseconds when the electric motor is operated at a short-term power limit of 200 kW.

At block 706, the method determines whether the gear shift is completed within a predetermined period of time. In some configurations, a shift is completed when there is sufficient velocity and positional synchronization between the coupling 140 and the target gear and the coupling 140 is moved by the actuator 142 to a position where the teeth of the coupling 140 mate or mesh with the teeth of the target gear. In some configurations, completion of a shift may be based on a signal from the from the coupling position sensor 216. For instance, a shift may be complete when the coupling 140 has moved along its rotational axis by a distance that indicates that there is meshing engagement between the teeth of the coupling 140 and corresponding engagement teeth of the target gear, such as inner gear teeth as previously discussed. A shift may not be complete when the coupling 140 has moved along its rotational axis by a lesser distance, which may be indicative of a blocked shift in which teeth of the coupling 140 have not been inserted into corresponding gaps between teeth of the target gear (e.g., gaps between the engagement teeth of the target gear). The predetermined period of time may be a constant or variable amount that may be based on performance attributes of the axle assembly or vehicle development testing. As a nonlimiting example, the predetermined period of time may be two seconds or less. If the shift is completed within the predetermined period of time, then the method may continue at block 708. If the shift is not completed within the predetermined period of time, then the method may continue at block 710.

At block 708, the gear shift is aborted. In some configurations, the gear shift may be aborted by commanding the coupling 140 to move to a neutral position, by changing the speed of the electric motor 46 back to speed immediately before the electric motor 46 was controlled to change its speed in anticipation or preparation for a gear shift, or combinations thereof. Aborting the shift may also include providing an error signal. The error signal may trigger a notification to the vehicle operator via the operator communication device 200, a diagnostic code to facilitate assessment and maintenance, or both. It is also contemplated that the method iteration may end and another iteration of the method or attempt to complete the gear shift may be made. The method may continue at block 710.

At block 710, the method reverts to operation using the long-term power and current limits of the traction battery or first electric power source 32. In some configurations, control system 36 may revert back to the long-term power and current limits previously in effect before executing the gear shift operation. In some configurations, the current state of charge of the first electric power source 32 and the temperature of the first electric power source 32 are used to reference a corresponding long-term power limit value and a long-term current limit value from an array of long-term power and current limit value values that are stored in a lookup table. The lookup table may be populated with long-term power and current limit value values based on vehicle development testing or drive axle system development testing.

Clause 1. A method of controlling a drive axle system of a vehicle, the method comprising: commanding a shift collar to move to a neutral position to disconnect an electric motor from a wheel hub; changing a rotational speed of the electric motor after commanding the shift collar to move to the neutral position; determining whether there is acceleration in response to changing the rotational speed of the electric motor; and reducing output torque provided by the electric motor when acceleration is detected.

Clause 2. The method of clause 1 wherein the shift collar is not in the neutral position when acceleration is detected.

Clause 3. The method of any preceding clause wherein the shift collar is coupled to a gear of a transmission that is connected to the electric motor when acceleration is detected.

Clause 4. The method of any preceding clause wherein reducing output torque provided by the electric motor comprises providing no output torque with the electric motor.

Clause 5. The method of any preceding clause further comprising decreasing output torque provided by the electric motor before commanding the shift collar to move to the neutral position.

Clause 6. The method of any preceding clause further comprising moving the shift collar to the neutral position when acceleration is detected.

Clause 7. The method of any preceding clause further comprising providing a notification to a vehicle driver when acceleration is detected.

Clause 8. The method of any preceding clause wherein the shift collar couples a gear of a transmission to a drive pinion that meshes with a differential assembly when acceleration is detected.

Clause 9. The method of any preceding clause wherein determining whether there is acceleration in response to changing the rotational speed of the electric motor comprises detecting acceleration of a drive pinion that meshes with a ring gear of a differential assembly.

Clause 10. The method of any preceding clause wherein determining whether there is acceleration in response to changing the rotational speed of the electric motor comprises detecting acceleration of an axle shaft that is connected to a differential assembly.

Clause 11. The method of any preceding clause wherein determining whether there is acceleration in response to changing the rotational speed of the electric motor comprises detecting acceleration of the wheel hub.

Clause 12. The method of any preceding clause wherein the shift collar is in the neutral position when acceleration is not detected.

Clause 13. The method of clause 12 further comprising synchronizing, with the electric motor, a rotational speed of a target gear of a transmission that is connected to the electric motor and a rotational speed of the shift collar when acceleration is not detected.

Clause 14. The method of clause 13 further comprising actuating the shift collar to engage the target gear after synchronizing the rotational speed of the target gear with the rotational speed of the shift collar.

Clause 15. A drive axle system comprising: an electric motor; a transmission connected to the electric motor, the transmission comprising at least a first gear and a second gear; a differential assembly connectable to first and second wheel hubs, respectively; a drive pinion that meshes with a ring gear of the differential assembly; a shift collar that is moveable between a first position in which the shift collar engages the first gear, a second position in which the shift collar engages the second gear, and a neutral position in which the shift collar does not engage the first gear and the second gear; and a control system that controls the electric motor and actuation of the shift collar, wherein the control system is configured to: command the shift mechanism to move the shift collar to the neutral position to disconnect the electric motor from the differential assembly; change a rotational speed of the electric motor after commanding the shift collar to move to the neutral position; determine whether there is acceleration in response to changing the rotational speed of the electric motor; and reduce output torque provided by the electric motor when acceleration is detected.

Clause 16. The drive axle system of clause 15 wherein no output torque is provided by the electric motor when the output torque is reduced.

Clause 17. The drive axle system of clause 15 or clause 16 wherein the shift collar engages the first gear or the second gear when acceleration is detected.

Clause 18. The drive axle system of any one of clauses 15 to 17 wherein the shift collar is moveable along the drive pinion and rotatable with the drive pinion.

Clause 19. The drive axle system of any one of clauses 15 to 18 wherein acceleration in response to changing the rotational speed of the electric motor is acceleration of the drive pinion caused by the electric motor.

Clause 20. The drive axle system of any one of clauses 15 to 19 further comprising an operator communication device, wherein the control system provides a notification to a vehicle driver when there is acceleration.

Clause 21. A method of controlling a drive axle system, the method comprising: determining a first acceleration rate of a first axle assembly comprising a first electric motor; determining a second acceleration rate of a second axle assembly comprising a second electric motor; comparing the first acceleration rate and the second acceleration rate, determining whether the first acceleration rate is within a predetermined amount of the second acceleration rate; and reducing a speed of the first electric motor the first axle assembly when the first acceleration rate is greater than the second acceleration rate and the first acceleration rate is not within a predetermined amount of the second acceleration rate.

Clause 22. The method of clause 21 further comprising reducing the speed of the second electric motor of the second axle assembly when the second acceleration rate is greater than the first acceleration rate and the first acceleration rate is not within a predetermined amount of the second acceleration rate.

Clause 23. The method of clause 21 or 22 further comprising not reducing the speed of the first electric motor of the first axle assembly when the first acceleration rate is greater than the second acceleration rate and the first acceleration rate is within a predetermined amount of the second acceleration rate.

Clause 24. The method of any of clauses 21 to 23 further comprising not reducing the speed of the second electric motor of the second axle assembly when the second acceleration rate is greater than the first acceleration rate and the first acceleration rate is within a predetermined amount of the second acceleration rate.

Clause 25. The method of any of clauses 21 to 24 wherein the first axle assembly does not transmit torque to the second axle assembly.

Clause 26. A method of controlling a drive axle system, the method comprising: determining a first stator temperature of a first stator of a first electric motor of a first axle assembly; determining a second stator temperature of a second stator of a second electric motor of a second axle assembly; comparing the first stator temperature and the second stator temperature; determining whether the first stator temperature and the second stator temperature differ by more than a first amount and less than a second amount; and providing a notification when the first stator temperature and the second stator temperature differ by more than the first amount and less than the second amount.

Clause 27. The method of clause 26 further comprising determining whether the first stator temperature and the second stator temperature differ by more than the second amount.

Clause 28. The method of clause 27 further comprising derating the first electric motor when the first stator temperature and the second stator temperature differ by more than the second amount and the first stator temperature exceeds the second stator temperature.

Clause 29. The method of clause 27 or clause 28 further comprising derating the second electric motor when the first stator temperature and the second stator temperature differ by more than the second amount and the second stator temperature exceeds the first stator temperature.

Clause 30. The method of any of clauses 26 to 29 further comprising not derating the first electric motor when the first stator temperature and the second stator temperature do not differ by more than the second amount.

Clause 31. A method of controlling a drive axle system, the method comprising: determining a first rotor temperature of a first rotor of a first electric motor of a first axle assembly; determining a second rotor temperature of a second rotor of a second electric motor of a second axle assembly; comparing the first rotor temperature and the second rotor temperature; determining whether the first rotor temperature and the second rotor temperature differ by more than a first amount and less than a second amount; and providing a notification when the first rotor temperature and the second rotor temperature differ by more than the first amount and less than the second amount.

Clause 32. The method of clause 31 further comprising determining whether the first rotor temperature and the second rotor temperature differ by more than the second amount.

Clause 33. The method of clause 32 further comprising derating the first electric motor when the first rotor temperature and the second rotor temperature differ by more than the second amount and the first rotor temperature exceeds the second rotor temperature.

Clause 34. The method of any of clauses 31 to 33 further comprising derating the second electric motor when the first rotor temperature and the second rotor temperature differ by more than the second amount and the second rotor temperature exceeds the first rotor temperature.

Clause 35. The method of any of clauses 31 to 34 further comprising not derating the first electric motor when the first rotor temperature and the second rotor temperature do not differ by more than the second amount.

Clause 36. A method of controlling a drive axle system, the method comprising: determining a first inverter temperature of a first inverter that is electrically connected to a first electric motor of a first axle assembly; determining a second inverter temperature of a second inverter that is electrically connected to a second electric motor of a second axle assembly; comparing the first inverter temperature and the second inverter temperature; determining whether the first inverter temperature and the second inverter temperature differ by more than a first amount and less than a second amount; and providing a notification when the first inverter temperature and the second inverter temperature differ by more than the first amount and less than the second amount.

Clause 37. The method of clause 36 further comprising determining whether the first inverter temperature and the second inverter temperature differ by more than the second amount.

Clause 38. The method of clause 36 or clause 37 further comprising derating the first electric motor when the first inverter temperature and the second inverter temperature differ by more than the second amount and the first inverter temperature exceeds the second inverter temperature.

Clause 39. The method of any of clauses 36 to 38 further comprising derating the second electric motor when the first inverter temperature and the second inverter temperature differ by more than the second amount and the second inverter temperature exceeds the first inverter temperature.

Clause 40. The method of any of clauses 36 to 98 further comprising not derating the first electric motor when the first inverter temperature and the second inverter temperature do not differ by more than the second amount.

Clause 41. A method of controlling a drive axle system, the method comprising: determining a total amount of torque requested; determining a first torque amount that is currently providable by a first electric motor of a first axle assembly determining a second torque amount that is currently providable by a second electric motor of a second axle assembly; determining whether the first electric motor and the second electric motor are capable of providing the total amount of torque requested based on a predetermined ratio; and providing the output torque with the first electric motor and the second electric motor based on the predetermined ratio when the first electric motor and the second electric motor are capable of providing the total amount of torque requested based on a predetermined ratio.

Clause 42. The method of clause 41 wherein the predetermined ratio provides 50% of the total amount of torque requested with the first electric motor and 50% of the total amount of torque requested with the second electric motor.

Clause 43. The method of clause 41 or clause 42 further comprising providing torque at the first output torque amount with the first electric motor when the first electric motor is not capable of providing the predetermined ratio of the total amount of torque requested and providing the remainder of the total amount of torque requested with the second electric motor.

Clause 44. The method of any of clauses 41 to 43 further comprising providing torque at the first torque amount with the first electric motor and providing torque at the second torque amount when the second electric motor is not capable of providing the predetermined ratio of the total amount of torque requested.

Clause 45. A method of controlling a drive axle system, the method comprising: determining a power limit and a current limit of an electric power source of the drive axle system, the drive axle system including a first axle assembly having a first transmission and a first electric motor that is configured to provide torque to the first transmission, wherein the first electric motor is electrically connected to the electric power source; temporarily enabling a short term power limit that exceeds the power limit and a short term current limit that exceeds the current limit; operating the electric motor up to the short term power limit and the short term current limit to synchronize the rotational speed of a shift collar with a target gear; and executing a gear shift by actuating the shift collar to engage the target gear.

Clause 46. The method of clause 45 further comprising determining whether the gear shift is completed within a predetermined period of time.

Clause 47. The method of clause 46 further comprising disenabling the short term power limit and the short term current limit and reinstituting operation of the electric motor up to the power limit and the current limit when the gear shift is completed within the predetermined period of time.

Clause 48. The method of clause 46 or clause 47 further comprising moving the shift collar to a neutral position when the gear shift is not completed within the predetermined period of time.

Clause 49 The method of clause 48 further comprising disenabling the short term power limit and the short term current limit and reinstituting operation of the electric motor up to the power limit and the current limit when the gear shift is completed within the predetermined period of time.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A method of controlling a drive axle system of a vehicle, the method comprising:
commanding a shift collar to move to a neutral position to disconnect an electric motor from a wheel hub;
changing a rotational speed of the electric motor after commanding the shift collar to move to the neutral position;
determining whether there is acceleration in response to changing the rotational speed of the electric motor; and
reducing output torque provided by the electric motor when acceleration is detected.

2. The method of claim 1 wherein the shift collar is not in the neutral position when acceleration is detected.

3. The method of claim 1 wherein the shift collar is coupled to a gear of a transmission that is connected to the electric motor when acceleration is detected.

4. The method of claim 1 wherein reducing output torque provided by the electric motor comprises providing no output torque with the electric motor.

5. The method of claim 1 further comprising decreasing output torque provided by the electric motor before commanding the shift collar to move to the neutral position.

6. The method of claim 1 further comprising moving the shift collar to the neutral position when acceleration is detected.

7. The method of claim 1 further comprising providing a notification to a vehicle driver when acceleration is detected.

8. The method of claim 1 wherein the shift collar couples a gear of a transmission to a drive pinion that meshes with a differential assembly when acceleration is detected.

9. The method of claim 1 wherein determining whether there is acceleration in response to changing the rotational speed of the electric motor comprises detecting acceleration of a drive pinion that meshes with a ring gear of a differential assembly.

10. The method of claim 1 wherein determining whether there is acceleration in response to changing the rotational speed of the electric motor comprises detecting acceleration of an axle shaft that is connected to a differential assembly.

11. The method of claim 1 wherein determining whether there is acceleration in response to changing the rotational speed of the electric motor comprises detecting acceleration of the wheel hub.

12. The method of claim 1 wherein the shift collar is in the neutral position when acceleration is not detected.

13. The method of claim 12 further comprising synchronizing, with the electric motor, a rotational speed of a target gear of a transmission that is connected to the electric motor and a rotational speed of the shift collar when acceleration is not detected.

14. The method of claim 13 further comprising actuating the shift collar to engage the target gear after synchronizing the rotational speed of the target gear with the rotational speed of the shift collar.

15. A drive axle system comprising:
an electric motor;
a transmission connected to the electric motor, the transmission comprising at least a first gear and a second gear;
a differential assembly connectable to first and second wheel hubs, respectively;
a drive pinion that meshes with a ring gear of the differential assembly;
a shift collar that is moveable between a first position in which the shift collar engages the first gear, a second position in which the shift collar engages the second gear, and a neutral position in which the shift collar does not engage the first gear and the second gear; and
a control system that controls the electric motor and actuation of the shift collar, wherein the control system is configured to:
command a shift mechanism to move the shift collar to the neutral position to disconnect the electric motor from the differential assembly;
change a rotational speed of the electric motor after commanding the shift collar to move to the neutral position;
determine whether there is acceleration in response to changing the rotational speed of the electric motor; and
reduce output torque provided by the electric motor when acceleration is detected.

16. The drive axle system of claim 15 wherein no output torque is provided by the electric motor when the output torque is reduced.

17. The drive axle system of claim 15 wherein the shift collar engages the first gear or the second gear when acceleration is detected.

18. The drive axle system of claim 15 wherein the shift collar is moveable along the drive pinion and rotatable with the drive pinion.

19. The drive axle system of claim 15 wherein acceleration in response to changing the rotational speed of the electric motor is acceleration of the drive pinion caused by the electric motor.

20. The drive axle system of claim 15 further comprising an operator communication device, wherein the control system provides a notification to a vehicle driver when there is acceleration.
